(19) United States
(12) Patent Application Publication
(10) Pub. No.: US 2003/0119677 A1
(43) Pub. Date: Jun. 26, 2003

(54) Tunable superconductor resonator

(76) Inventors: Ma Qiyan, Milburn, NJ (US); Erzhen Gao, Milburn, NJ (US)

Correspondence Address: Steven R. Bartholomew, Esq., Morgan, Lewis & Bockius, LLP, 43rd Floor, 101 Park Avenue, New York, NY, 10178, US

(21) Appl. No.: 10/282,969

(22) Filed: Oct. 29, 2002

Related U.S. Application Data
(60) Provisional application No. 60/334,835, filed on Oct. 31, 2001.

(51) Int. Cl. H01P 7/00; H01B 12/02

(52) U.S. Cl. 505/210; 333/99 S; 333/235

(57) ABSTRACT

A tunable superconductor resonator including a superconductor resonator coil and a variable capacitance portion. The superconductor resonator is adjustable to a first resonant frequency and a second resonant frequency. A variable capacitance portion is electrically coupled to the superconductor resonator coil to vary electrical capacitance between a first capacitance and a second capacitance. The variable capacitance portion providing the first capacitance adjusts the superconductor resonator to its first resonant frequency. The variable capacitance portion providing the second capacitance adjusts the superconductor resonator to its second resonant frequency. Different aspects of the tunable superconductor resonator can be tuned using dynamic tuning and/or static tuning techniques.

### CROSS REFERENCE TO RELATED APPLICATIONS

This application claims priority to U.S. Provisional Patent Application Serial No. 60/334,835, filed Oct. 31, 2001.

### FIELD OF THE INVENTION

This invention relates to tunable resonators, and more particularly, to tunable superconductor resonators including a superconducting material.

### BACKGROUND OF THE INVENTION

High-temperature superconducting (HTS) materials have been considered for such devices as thin-film resonators and filters since their discovery. Use of superconducting materials in electrical devices promise high quality factors (Q) due to low electrical losses. One difficulty with prior art tunable superconductor resonators using superconductors, however, is that the quality factor (Q) drops off considerably as the frequency of operation deviates slightly from a relatively narrow band of frequencies.

High frequency radio frequency (RF) resonators have been discussed in the article “RF Applications of High Temperature Superconductors in MHz Range,” IEEE Transactions on Applied Superconductivity (June 1999) (incorporated herein by reference). Tunable superconductor resonators operate within a predesignated frequency range. Designing superconductor resonators to operate at radio frequencies in the 3-30 MHz range results in prohibitively large and heavy resonator designs. Such designs of tunable superconductor resonators are unsuitable for many applications such as aviation, communication, space, etc.

### OBJECTS AND SUMMARY OF THE INVENTION

One object of the invention is to improve the actuation time of prior-art tunable superconductor resonator devices. Another object of the invention is to provide a high frequency superconductor resonator that occupies a relatively compact area or volume. Still another object of the invention is to provide a superconductor resonator having a relatively high quality value (Q) across a reasonably broad range of potential operating frequencies.

Pursuant to a preferred embodiment of the invention, the foregoing and other objects of the invention are achieved in the form of a tunable superconductor resonator that is tuned by controlling the superconducting state of at least one resonator element. The resonator elements include a superconductor resonator coil and a variable capacitance portion. The superconductor resonator is tuned between a first resonant frequency and a second resonant frequency. The variable capacitance portion is electrically coupled to the superconductor resonator coil and varies its electrical capacitance between a first capacitance state and a second capacitance state. This variation in the capacitance state acts to adjust the resonant frequency of the superconductor resonator between its first resonant frequency and its second resonant frequency. The variable capacitance portion includes a first superconductor film portion that is capacitively coupled to a second superconductor film portion. The first superconductor film portion is electrically connected to the superconductor resonator coil. The second superconductor film portion includes a superconductor trace. The superconductor trace can transition between a superconducting state and a normal (non-superconducting) state, wherein, when the superconductor trace is in its superconducting state, the variable capacitance portion is placed in its first capacitance state. When the superconductor trace is in its normal state, the variable capacitance portion is placed in its second capacitance state.

Pursuant to another preferred embodiment of the present invention, a dynamically tunable superconductor resonator includes a superconductor resonator coil and a variable capacitance portion. The superconductor resonator is configured to be tunable between a first resonant frequency and a second resonant frequency. The resonant frequencies are tuned by controlling at least one of: (a) the superconducting state of at least one resonator element, such as a variable capacitance portion and/or an inductive portion, and (b) adjusting the capacitance of the variable capacitance portion via mechanical displacement. In any case, the variable capacitance portion is equipped to transition between a first capacitance state and a second capacitance state. Adjusting the variable capacitance portion to its first capacitance state adjusts the superconductor resonator to its first resonant frequency. Adjusting the variable capacitance portion to its second capacitance state adjusts the superconductor resonator to its second resonant frequency. The variable capacitance portion includes a movable substrate, a MEM, piezoelectric, or mini-electric motor actuator, and superconductor film portions electrically connected to opposite ends of the superconductor resonator coil. The movable substrate has at least one further superconductor film portion deposited thereon. The actuator adjusts the variable capacitance by displacing the further superconductor film portion relative to the other superconductor film portions.

### BRIEF DESCRIPTION OF THE DRAWINGS

FIG. 1 shows a top view of one embodiment of a tunable superconductor resonator including a spiral superconductor resonator coil;

FIG. 2 is a top view of another embodiment of a tunable superconductor resonator including an interdigitated superconductor resonator coil;

FIG. 3 is a perspective view of an embodiment of an actuator that may be included with any of the tunable superconductor resonators of FIGS. 1 and 2;

FIG. 4 is a perspective view of another embodiment of an actuator that may be included with any of the tunable superconductor resonators of FIGS. 1 and 2;

FIGS. 5A, 5B, and 5C show one embodiment of the tunable superconductor resonator including a superconductor resonator coil; FIG. 5A shows a perspective view of the superconductor resonator coil including an impedance matching circuit; FIG. 5B shows a top view of one layer of the superconductor resonator coil shown in FIG. 5A, wherein the first layer includes the superconductor resonator coil, a pick up loop, and non-movable pads of the impedance matching circuit; and FIG. 5C shows a top view of the second layer of the superconductor resonator coil of FIG. 5A, the second layer including movable pads of the impedance matching circuit and electrical conductors;

FIG. 6 shows a perspective view of another embodiment of the tunable superconductor resonator including a micro-electromechanical (MEM) actuator;

FIG. 7 shows a top view of another embodiment of the tunable superconductor resonator including a variable capacitance portion;

FIG. 8 shows a top view of another embodiment of the tunable superconductor resonator including a static actuation portion;

FIG. 9 shows a top view of yet another embodiment of the tunable superconductor resonator including a variable capacitance portion;

FIG. 10 shows a detailed view of a portion of the variable capacitance portion shown in FIG. 9;

FIG. 11 shows a detailed view of another embodiment of the variable capacitance portion;

FIG. 12 shows a top view of a device that measures voltage across a strip of superconducting material;

FIG. 13 shows a graph plotting the ratio of resonant frequencies of the variable capacitance portion versus the ratio of areas for the tunable superconductor resonator;

FIG. 14 shows a detailed view of yet another embodiment of a portion of a variable-capacitance portion;

FIG. 15 shows a top view of one embodiment of the tunable superconductor resonator including another embodiment of variable capacitance portion;

FIG. 16 shows an expanded view of the variable capacitance portion of FIG. 15;

FIG. 17 is a flowchart setting forth an embodiment used to apply a static or a dynamic tuning technique to the tunable superconductor resonator;

FIG. 18A shows a perspective view of another embodiment of the tunable superconductor resonator including a variable capacitance portion, and FIG. 18B shows an expanded view of the variable capacitance portion of FIG. 18A;

FIG. 19 sets forth an equivalent electrical circuit diagram for the embodiment of the tunable superconductor resonator of FIG. 18A;

FIG. 20A shows another embodiment of a tunable superconductor resonator;

FIG. 20B shows an expanded view of the variable capacitance portion of FIG. 20A;

FIG. 21 sets forth an equivalent electrical circuit diagram for the embodiment of the tunable superconductor resonator of FIG. 20A;

FIG. 22 shows an embodiment of the tunable superconductor resonator including an optical heater assembly, such as a laser; and

FIG. 23 shows an embodiment of the tunable superconductor resonator including a magnetic field generator.

Throughout the figures, the same reference numerals and characters may denote like features, elements, components or portions of the illustrated embodiments.

### DETAILED DESCRIPTION OF THE PREFERRED EMBODIMENTS

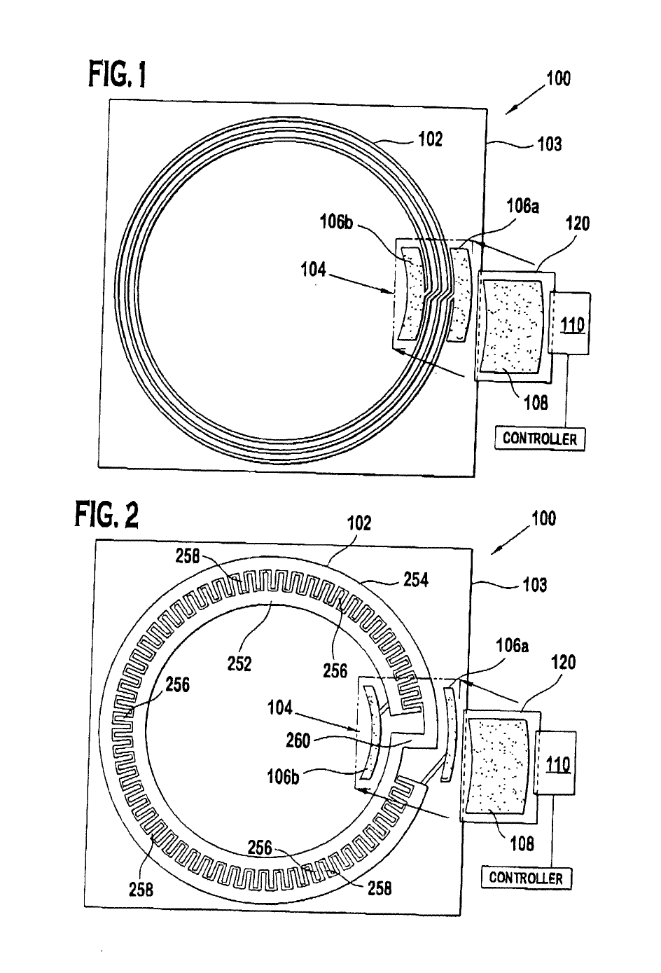

This disclosure sets forth multiple embodiments of a tunable superconductor resonator 100. The tunable superconductor resonator 100 is capable of receiving and transmitting electromagnetic signals. The tunable superconductor resonator 100 shown in FIG. 1 includes a superconductor resonator coil 102 and a variable capacitance portion 104. The variable capacitance portion tunes the tunable superconductor resonator 100. The tunable superconductor resonator 100 may be a stand-alone device or integrated as a component in another device (such as a superconductor filter). The superconductor resonator coil 102 can be formed as a spiral superconductor resonator coil as shown in FIG. 1, or as an interdigitated superconductor resonator coil having interdigital fingers as shown in FIG. 2. This disclosure also describes various tuning and manufacturing techniques associated with the tunable superconductor resonator 100.

The superconductor resonator coil 102 is deposited and etched on a primary substrate 103 using such processes as chemical vapor deposition, physical vapor deposition, or electrochemical deposition. One embodiment of the variable capacitance portion 104 includes two superconductor film portions 106a and 106b, a superconductor film portion 108, and, in some embodiments, an actuator 110. The actuator 110 displaces the superconductor film portion 108 relative to the superconductor film portions 106a, 106b to vary the capacitance therebetween. The superconductor film portion 106a electrically connects to an opposite end of the superconductor resonator coil 102 from the superconductor film portion 106b. An electric current source applied to superconductor film portions 106a, 106b produces an electric current flowing through the superconductor resonator coil 102.

The resonant frequency of the tunable superconductor resonator 100 can be tuned in both dynamic and static tunable superconductor resonators by altering the capacitance of the variable capacitance portion 104. Certain embodiments of the variable capacitance portion 104 alter capacitance by physically displacing the superconductor film portion 108 and/or the superconductor film portions 106a, 106b. These embodiments of the variable capacitance portion 104 are referred to herein as dynamically tuned superconductor resonators. Such relative displacement utilizes devices such as MEM actuators, piezoelectric actuators, or other types of actuators. Other embodiments of the variable capacitance portion 104 alter capacitance by varying the conductive state (between superconducting and non-superconducting) of certain portions of the variable capacitance portion, and are referred to herein as statically tuned superconductor resonators. This disclosure describes embodiments of both dynamically tunable superconductor resonators and statically tunable superconductor resonators. This disclosure further describes how the functionality of the dynamically tunable superconductor resonator and statically tunable superconductor resonator can be integrated into a single tunable superconductor resonator 100.

Different embodiments of the variable capacitance portion 104 use different techniques to provide tuning of the superconductor resonator coil 102 of the tunable superconductor resonator 100. The tunable superconductor resonator 100 may use either dynamic or tuning static tuning of the variable capacitance portion 104, or both. Dynamic tuning of the variable capacitance portion 104 can be performed by applying a signal that physically displaces one portion of the variable capacitance portion 104 relative to another portion of the variable capacitance portion. Such physical displacement of the relatively-moving portions result in an effective change in the capacitance of the variable capacitance portion that alters the resonant frequency of the tunable superconductor resonator 100. Different actuators that can be used for dynamic tuning include, for example, piezoelectric devices, micro-electromechanical (MEM) devices, mini-electric motors, or the like.

Static tuning of the tunable superconductor resonator 100 involves applying a control signal to alter the capacitance of the variable capacitance portion 104 (so as to change the resonant frequency of the tunable superconductor resonator 100) without requiring any mechanical displacement of any portion of the variable capacitance portion 104. Certain embodiments of statically tunable superconductor resonators 100 include one or more superconductor traces extending between electrical contacts points. The superconductor traces can be transitioned between their superconducting and non-superconducting states (e.g., functionally turned on and off) to alter the capacitive properties of the variable capacitance portion. Altering the states of the superconductor traces thereby tunes the statically tunable superconductor resonator 100. Both static tuning and dynamic tuning may be used in combination, or simultaneously, to tune the tunable superconductor resonator 100.

Several terms used throughout the disclosure are now described. The term “superconducting” describes a material whose electrical resistance decreases to effectively zero when the temperature of the material is maintained below a critical temperature (T_{C}); the electrical current density of the material is maintained below a critical electrical current density (J_{C}) value; and the magnetic field applied to the material is maintained below a critical magnetic field (H_{C}) value. If any one of the temperature, the electric current density, or the magnetic field is raised above their respective critical values (J_{C}, T_{C}, or H_{C}), the superconductor material transitions to its normal state. The term “superconductor” describes a resonator, filter, or other device that includes a component that is at least partially formed from a superconducting material. The values of the J_{C}, T_{C}, and H_{C} for superconducting materials are each dependant on the chemical composition of the material and on the presence or absence of defects in the superconducting material.

The term “superconducting material” includes, but is not limited to, so-called high-temperature superconducting (HTS) materials, metallic superconducting materials, compound superconducting materials, and oxide superconducting materials. Metallic superconducting materials include those superconducting materials that are formed from a single metal, such as Nb. Compound superconducting materials include those superconducting materials that are formed from a compound of materials, such as MgB₂, NbSe, and NbTi. Oxide superconducting materials include those superconducting materials that are formed from oxides of compound or metallic superconducting materials. Examples of oxide superconducting materials include YBaCuO and TlBaCaCuO. Specifically described superconducting materials are intended to be exemplary in nature, and not limiting in scope, since a variety of superconducting materials are presently known, and more superconducting materials are often being discovered.

Several different embodiments of dynamically tunable superconductor resonators are now described. Statically tunable superconductor resonators will be described in greater detail hereinafter.

Dynamically Tunable Superconductor Resonators

This portion relates to tunable superconductor resonators 100 that are tuned using dynamic tuning techniques. The embodiment of tunable superconductor resonator 100 shown in FIG. 1 includes the superconductor resonator coil 102 that is dynamically tuned by controlling the electric current that is applied to piezoelectric devices, micro-electromechanical (MEM) actuators, or mini-electric motor actuators 110. Actuation of the actuators 110 results in a variation in the capacitance of the variable capacitance portion 104. Changing the capacitance of the variable capacitance portion 104 alters the natural frequency or resonant frequency of the superconductor resonator 100. The superconductor film portions 106a, 106b are layered on the primary substrate 103. The superconductor film portions 106a and 106b are connected to the superconductor resonator coil 102, and are functionally included as a portion of the variable capacitance portion 104. The superconductor film portion 108 (that is a portion of the variable capacitance portion) is deposited on the secondary substrate 120. During operation, the face of the secondary substrate 120 (on which the superconductor film portion 108 is layered) is positioned proximate the face of the primary substrate 103 (on which superconductor film portions 106a, 106b are layered). In one embodiment, the secondary substrate 120 is parallel to, and spaced from, the primary substrate 103.

The primary substrate 103 and the secondary substrate 120 of the tunable superconductor resonator 100 may each be formed to be structurally rigid or flexible depending on the materials used and the intended use and environment of the tunable superconductor resonator. The variable capacitance portion 104 is tuned, in certain embodiments, by displacing the superconductor film portion 108 relative to the superconductor film portions 106a, 106b. Displacing either substrate 103 or 120 relative to the other respective substrate (120 or 103) changes the capacitance of the variable capacitance portion 104.

One embodiment of actuator 110 is driven by a MEM actuator. Different embodiments of actuators 110 can displace either the primary substrate 103 with the superconductor film portions 106a, 106b relative to the secondary substrate 120; the secondary substrate 120 with the superconductor film portion 108 relative to the primary substrate 103; or both substrates 103 and 120 relative to each other. Such displacement can occur in relative lateral or axial directions or both. Such relative displacement of the superconductor film portions 106a, 106b relative to the superconductor film portion 108 acts to change the capacitance of the variable capacitance portion 104. Displacement of one or more of the superconductor film portions 106a and 106b or the superconductor film portion 108 in a lateral direction would be taken in a direction within a plane parallel to the paper as shown in FIG. 1.

The primary substrate 103 provides structural rigidity and protection to the superconductor film portions 106a, 106b. The secondary substrate 120 provides structural rigidity and protection to the superconductor film portion 108. The secondary substrate 120 may be relatively small (e.g., 100 μm×100 μm or 1 mm×1 mm) or larger as desired or required by the application or design. Making the secondary substrate 120 relatively small allows it to be mounted to a piezoelectric device, a MEM device, or a mini-electric motor device (that are also quite small). The secondary substrate 120 can be displaced to alter the capacitance of the variable capacitance portion 104. One embodiment of the variable capacitance portion 104 is an inductive device that operates based on the inductive association established between the superconductor film portions 106a, 106b and the superconductor film portion 108. Certain embodiments of the superconductor film portions 106a, 106b and/or the superconductor film portion 108 may be substantially rectangular and planar, or another shape that is planar as described or desired.

It is preferred that the superconductor resonator coil 102 be formed from, or partially formed from, the superconducting material as described above in any of the embodiments of the present invention. Since the value of the critical temperature T_{C} is very low, the superconducting material forming such components as the superconductor resonator coil 102 must be refrigerated to controllably allow the superconducting material to be transitioned into, and out of, its superconducting state. If the superconducting material is maintained above its critical temperature, the superconducting material will remain in its normal (non-superconducting) state. The superconducting material can be refrigerated to its superconducting state by, e.g., placing the superconducting material in a cryostatic chamber filled with refrigerated liquid nitrogen or liquid helium.

Certain embodiments in this disclosure describe dynamic tuning to alter the resonant frequency of the tunable superconductor resonator 100. One such embodiment involves a resonator coil 102 deposited on a substrate. In dynamic tuning of the tunable superconductor resonator 100, the resonant frequency of the resonator coil is related to the dielectric constant of materials which are in physical proximity to the resonator coil 102. Physical proximity provides electric and/or magnetic field coupling between the resonator coil and such dielectric materials.

Altering the dielectric constant of such a physically proximate material changes the resonant frequency of the tunable superconductor resonator 100, so as to provide adjustment of the resonant frequency. A piece of dielectric material, called a ferrite, can be deposited on the resonator coil 102 of the tunable superconductor resonator 100 to change the dielectric constant (and therefore the resonant frequency) of the coil 102. The ferrite material (in one embodiment implemented using a ferrite known as YEG) is deposited on the resonator coil 102. A current is then flowed into this material, or voltage is applied across this material, to change the dielectric constant of the material.

Tunable superconductor resonators 100 may be designed to operate in the frequency range typically devoted to telecommunications devices (from 1 MHz to 5 GHz). Different embodiments of the tunable superconductor resonator 100 may be suitable for microwave, space, and other applications extending in frequency to 20 GHz and above, while maintaining the tunable superconductor resonator within reasonable package dimensions and weight.

Certain embodiments of a variable capacitance portion 104 include a so-called flip chip comprising a first flip chip film portion and a second flip chip film portion. Each flip chip film is proximately positioned to provide an operational flip chip using two distinct flip chip portions with superconducting material layered on one side. This proximity is accomplished by physically flipping one of the flip chip portions over so the faces of both flip chip film portions (including the superconductor resonator coil and/or other patterns formed from superconducting material) are positioned relative to each other. In one embodiment, the primary substrate 103 may be the first flip chip portion and the secondary substrate 120 is the second flip chip portion. In different embodiments, the side of the secondary substrate 120 on which the superconductor film portion 108 is deposited may alternatively face, or be directed away from, the side of the primary substrate 103 on which the superconductor film portions 106a, 106b are deposited. In different embodiments, one or both of the superconductor film portions 106a, 106b can be deposited on the surface of the primary substrate 103 facing, or directed away from the secondary substrate 120. During operation, flip chips using MEM, mini-electric motor, or other technology can provide positional displacement to within a one micron accuracy. The substrates 103, 120 can be produced using technology other than flip-chip technology.

The superconductor film portions 106a, 106b and the superconductor film portion 108 may also be modeled as two pairs of parallel plate capacitors that form an integral portion of the variable capacitance portion 104. Each parallel plate of the parallel plate capacitor is positioned substantially parallel and proximate to the other plate. In the embodiments of the tunable superconductor resonator 100 shown in FIG. 1 or 2, each one of the plates can move in a direction substantially perpendicular to both plates to provide active tuning. The shape and size of both the varying capacitive end points and the superconductor resonator coil film can be selected to provide the desired range of resonant frequency tunability. A variety of variable capacitance portion configurations can be provided considering parallel plate capacitor principles and designs, the general concepts of which are well known to skilled artisans.

During tuning of the tunable superconductor resonator 100, one or more of: (a) the dielectric constant of the superconducting material of the superconductor resonator coil, (b) the dielectric constant of a material in proximity to the superconductor resonator coil, and (c) the dielectric constant of the material on which the superconductor resonator coils is formed, may be changed. In any case, voltage applied across the dielectric material changes the dielectric constant of the dielectric material, which, in turn, changes the resonant frequency of the superconductor resonator coil and, hence, the superconductor resonator. Changing the permeability of superconducting material to effect the magnetic properties is referred to as magnetic coupling. Changing the magnetic field in the superconductor resonator coil 102 changes the permeability of the superconductor resonator coil 102. This embodiment of tuning the tunable superconductor resonator 100 therefore provides a mechanism for dynamic tuning.

In certain embodiments, the superconductor resonator coil 102 is coated with a ferromagnetic material to enhance the magnetic coupling. The electrical characteristics of the tunable superconductor resonator 100 can be modified by selecting any of different ferromagnetic materials to deposit on the superconductor resonator coil 102. The superconductor resonator coil 102 of the tunable superconductor resonator 100 may be considered an inductive portion, while the varying capacitance portion 104 may be considered a capacitive portion. When the capacitance of the variable capacitance portion 104 is altered (by either static or dynamic tuning), the resonant frequency of the tunable superconductor resonator 100 is tuned.

Changing the dielectric constant to modify the resonant frequency of the tunable superconductor resonator 100, as described in the foregoing paragraph, causes a corresponding change in the permeability of the superconductor resonator. Changing the permeability to dynamically tune the tunable superconductor resonator 100 also (unfortunately) results in a decrease of the quality factor (Q). The quality factor (Q) measures the ratio of reactance to resistance at the operating (i.e., resonant) frequency of tunable superconductor resonator 100, and is expressed as a ratio of 1 or lower, with a value of 1 representing the ideal value. It is desirable to provide a tunable superconducting resonator 100 that can be tuned using a variable capacitance in which the Q factor does not decrease significantly.

FIG. 2 shows an embodiment of the tunable superconductor resonator 100 that includes the superconductor resonator coil 102 with an inner turn 252 and an outer turn 254. The embodiments of superconductor resonator coil 102, similar to as shown in FIGS. 1 and 2, can be used alternatively in embodiments of the tunable superconductor resonators 100 described herein. The superconductor resonator coil 102 in FIG. 2 includes interdigitated fingers 256 and 258 that extend radially in the space between, and are electrically connected to, the respective inner turn 252 and outer turn 254. The use of interdigital fingers increases the capacitance of the superconductor resonator coil 102 and affects the resonant frequency range of the tunable superconductor resonator 100. Interdigitated fingers 256 are mounted to inner turn 252. The interdigitated fingers 256 are interspersed with (and are inductively coupled to) adjacent interdigitated fingers 258. Interdigitated fingers 258 are mounted to outer turn 254. Interdigitated fingers 256, 258 may extend completely around the periphery of, in the space between, the respective inner turn 252 and the outer turn 254. Alternatively, interdigitated fingers 256, 258 may be removed from, or not inserted in, certain regions of the periphery of the inner turn 252 and the outer turn 254 to modify the reactance of the superconductor resonator coil 102.

Increasing the number of pairs of interdigitated fingers 256, 258 that are provided in the embodiment shown in FIG. 2 increases the capacitance of the variable capacitance portion 104. An electrical capacitor is formed from two electrodes separated by an electrical insulator. Each pair of interdigitated fingers thus acts as a capacitor that contributes to the total capacitance of the variable capacitance portion 104, whose total capacitance can be designed by controlling the distance between all of the pairs of interdigitated fingers. The capacitance of the variable capacitance portion 104 can be adjusting by altering the spacing between the superconductor film portions 106a, 106b and the superconductor film portion 108. The embodiment of the variable capacitance portion 104 includes interdigitated fingers having a gap provided between each adjacent pair of adjacent interdigitated fingers. The capacitance of all of the adjacent pairs of interdigitated fingers contribute to the total capacitance for the variable capacitance portion 104.

By using interdigitated fingers, the physical dimensions of the superconductor resonator coil 102 can be made relatively small while still providing a relatively large capacitance. The capacitance between all of the interdigitated fingers 256 in the inner turn 252, and all of the interdigital fingers 258 of the outer turn 254, combining with the capacitance of the variable capacitance portion 104 has to be factored in to determine the total capacitance of the tunable superconductor resonator 100. Considering the large number of closely spaced sets of interdigitated fingers 256, 258, a considerable amount of capacitance can be created within a relatively small superconductor resonator coil 102 as shown in FIG. 2. Changing the relative portions and overlays of the interdigitated fingers 256, 258 results in a change in the capacitance (and the resonant frequency) of the overall tunable superconductor resonator 100. Considering the structure of the embodiment of superconductor resonator coil 102 shown in FIG. 2, the distance between adjacent interdigitated fingers 256, 258 (or number of pairs of interdigitated fingers) can be designed to provide a desired total capacitance of the tunable superconductor resonator, considering the capacitance of the variable capacitance portion 104. The actuators 110 laterally displacing the substrates 103, 120 can provide relative displacement to the superconductor film portion 108 or superconductor film portions 106a and 106b.

Other illustrative embodiments of the superconductor resonator coil 102 may be provided in circular, rectangular, or other closed-loop configurations. One embodiment of the superconductor resonator coil 102 is formed as a rectangle (or square) with each side of the rectangular resonator coil 102 (not shown) being approximately 25 mm and having a thickness of 2 mm. The non-movable portion of the variable capacitance portion can be formed of two portions each 5 mm square and separated by 0.5 mm. The superconductor film portion 108 on the secondary substrate 120 is 5 mm in width and 10 mm in length.

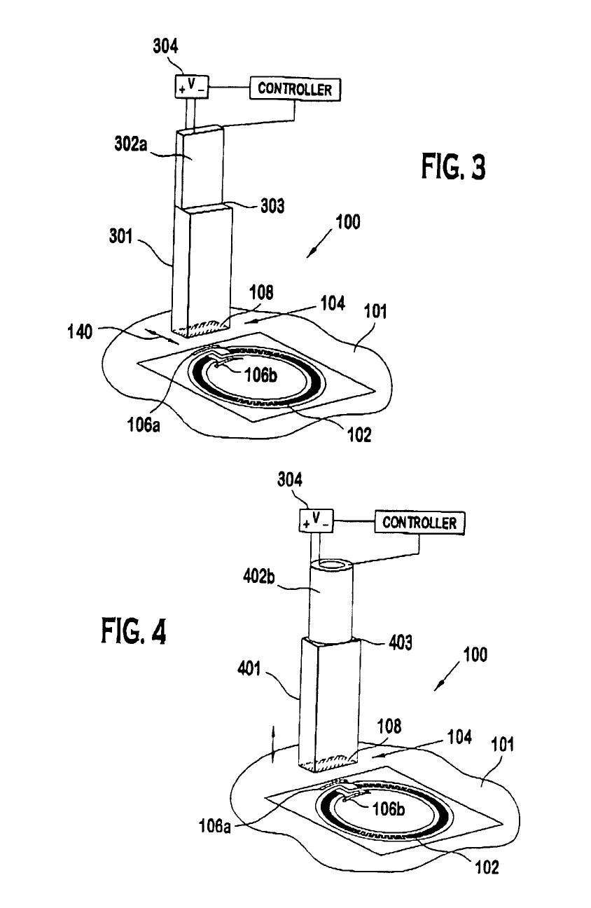

FIGS. 3 and 4 illustrate a perspective view of two alternative embodiments of a continuously tunable superconductor resonator 100. As illustrated in FIGS. 3 and 4, the respective secondary substrate 120 is mounted on an actuator 110 for controllably moving the secondary substrate 120 relative to the primary substrate 103. During operation, the distance between the superconductor film portion 108 on the secondary substrate 120 and the superconductor film portions 106a, 106b on the primary substrate 103 ranges from a micron to a few millimeters in certain embodiments. The actuator 110 has a movable end 503 that can be displaced relative to the primary substrate 103 in response to an applied control signal from the control voltage 304 as shown in FIGS. 3 and 4. The superconductor film portion 108 of the secondary substrate 120 is connected to the movable end 503 of the actuator 110. The superconductor film portion 108 is capacitively coupled to the superconductor film portions 106a, 106b on the primary substrate 103. Accordingly, through the application of the control signal 304, the capacitance of the variable capacitance portion 104 can be altered by changing the relative position of the secondary substrate 120 and the primary substrate 103. The control voltage 304 in certain embodiments can range from positive 30V to negative 30V (depending upon the type of actuator 110 used). The operating frequency of the superconductor resonator coil 102 of the tunable superconductor resonator 100 changes as a function of the capacitance of both the variable capacitance portion 104 and the superconductor resonator coil. The frequency of the tunable superconductor resonator 100 can therefore be tuned within a range which is a function of the relative capacitances provided by the variable capacitance portion 104 and the superconductor resonator coil 102.

In the embodiment of tunable superconductor resonator 100 shown in FIG. 3, a piezoelectric bender 302a produces motion that is lateral relative to the body of the actuator 110 as shown by arrow 140. A control voltage 304 is applied to the piezoelectric bender 302a to control the motion of the piezoelectric bender 302a. The piezoelectric bender 302a therefore can displace the secondary substrate 120 in a direction substantially parallel to the plane of the primary substrate 103 as indicted by the arrow 140. In an alternate embodiment of the tunable superconductor resonator 100 shown in FIG. 4, the actuator 110 includes a piezoelectric tube 402b. The piezoelectric tube 402b can be actuated by applying a control voltage 304 to displace the secondary substrate 120 in a direction substantially perpendicular to the plane of the primary substrate 103 as indicated by arrow 141. Piezoelectric multilayer bender actuators and piezoelectric tube actuators are commercially available from a variety of commercial vendors such as Polytec PI, Inc. of Auburn, Mass.

Different embodiments of the above described tunable superconductor resonators 100 may be configured to provide a variety of resonant frequencies. For example, one embodiment of tunable superconducting resonators using piezoelectric actuators may be tuned in frequency from 1 MHz to 10 GHz. Using MEM or mini-electric motor actuated devices typically provides a resonator ranging in frequency from a few MHz to less than 5 GHz.

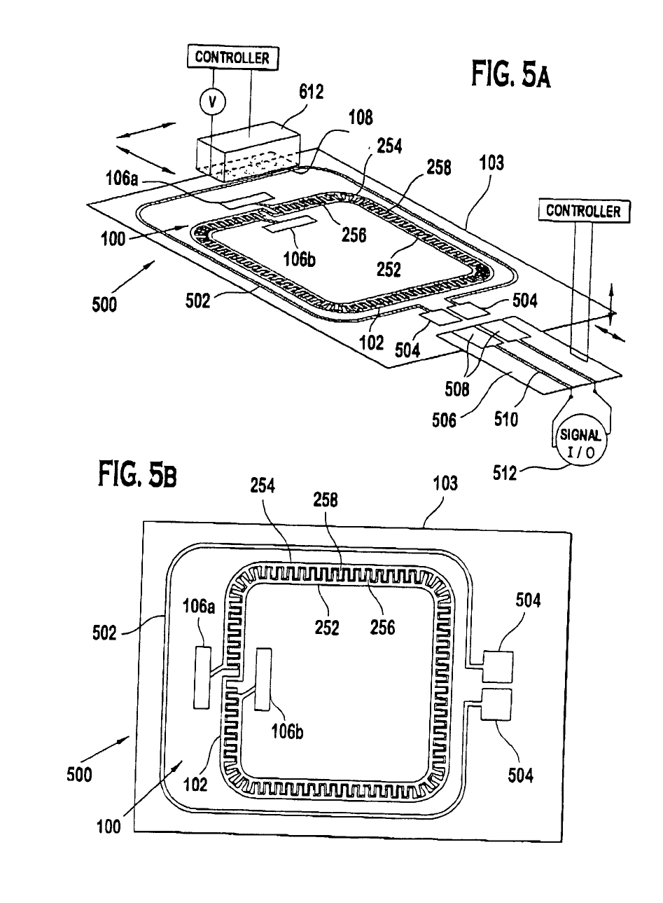

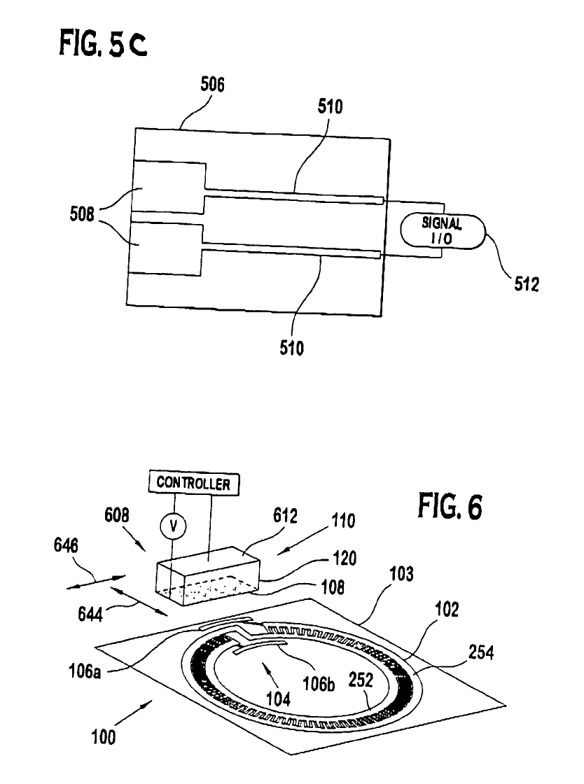

One embodiment of a tunable superconductor resonator coil assembly 500 is shown in FIGS. 5A, 5B, and 5C. FIG. 5A shows a perspective view of the tunable superconductor resonator coil assembly 500 that includes the tunable superconductor resonator 100, which further includes the superconductor resonator coil 102. Different embodiments of the superconductor resonator coil 102 are as described herein relative to FIGS. 1, 2, 3, 4, 5A and 5B. The superconductor coil assembly 500 additionally includes an impedance matching circuit 511 and a pick-up loop 502 formed of a layered superconductor material. The impedance matching circuit 511 includes at least one I/O pad 504 (two are shown) formed on the primary substrate, at least one I/O pad 508 (two are shown), and at least one electrical conductor 510 (two are shown) formed on the movable substrate 506.

Each of the pick-up loops 502, the superconductor resonator coil 102, and the I/O pads 504 are layered (e.g., deposited and etched) on the primary substrate 103. The I/O pads 504 are electrically coupled to peripheral ends of the pick-up loop 502. In one embodiment, the pick-up loop 502 extends around the periphery of the superconductor resonator coil 102. During operation, the movable portion 506 of the impedance matching circuit 511 is positioned in close proximity to the I/O pads 504. The movable portion 506 includes the I/O pads 508 layered thereupon, a transmission line 510, and electrical connections to a signal I/O 512. The transmission line 510 is electrically connected to each one of the I/O pads 508. The signal I/O 512 is therefore electrically coupled to at least one of the I/O pads 508. By controlling positioning of the I/O pads 508 relative to the I/O pads 504, a controllable capacitance is established therebetween. This controllable capacitance provides impedance matching between the superconductor resonator coil 102, the pick-up loop 502, and any circuit connected to the transmission line 510, such as signal I/O 512. This displacement between the I/O pads 508 and the I/O pads 504 is controlled by an impedance matching controller 590.

One embodiment of a top view of the layout of the pick-up loop 502 of the tunable superconductor resonator coil assembly 500 on the primary substrate 103 (around the superconductor resonator coil 102) is shown in FIG. 5B. Similarly, one embodiment of the layering of the I/O substrate 506 of the impedance matching circuit 511 of the tunable superconductor resonator coil assembly 500 is shown in FIG. 5C.

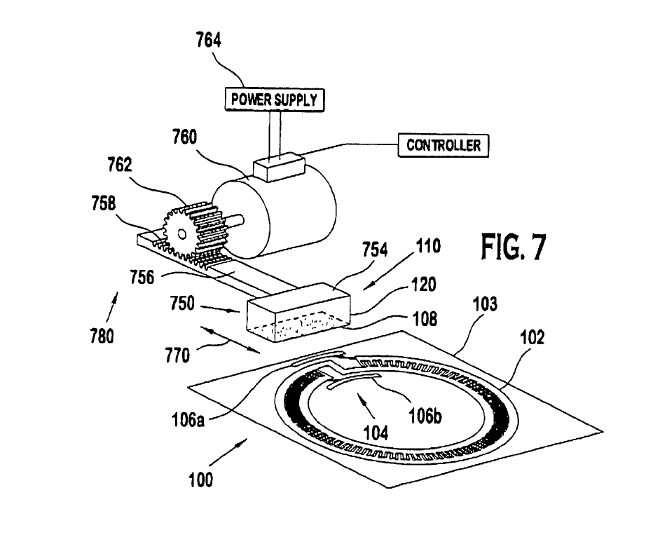

FIG. 6 shows an embodiment of tunable superconductor resonator 100 using an MEM actuator 612. The MEM actuator 612 tunes the resonant frequency of the superconductor resonator coil 102 included within the tunable superconductor resonator 100. FIG. 7 shows another embodiment of tunable superconductor resonator 100 including a micro-motor. The MEM actuator 612 shown in FIG. 6 and the mini-electric motor 780 shown in FIG. 7 displace the secondary substrate 120 relative to the primary substrate 103, and therefore dynamically tune the resonant frequency of the superconductor resonator coil 102. The embodiments of actuators of FIGS. 6 and 7 can be configured as the embodiments of the superconductor resonator coil 102 used in the tunable superconductor resonator 100 as described above.

In the FIG. 6 embodiment of a tunable superconductor resonator 100 (including the superconductor resonator coil), the MEM actuator 612 displaces the secondary substrate 120 in a lateral direction indicated by arrow 644 or by arrow 646 depending on the design of the MEM actuator. The superconductor film portion 108 and the MEM actuator 612 can each be deposited on the secondary substrate 120 to provide for displacement of the superconductor film portion 108 relative to one or more of the superconductor film portions 106a, 106b.

Lateral displacement of the superconductor film portion 108 relative to the superconductor film portions 106a, 106b in the direction indicated by arrows 644 or 646 changes the overlap of the superconductor film portion 108. In one embodiment, the superconductor film portion 108 is substantially parallel to each of the superconductor film portions 106a, 106b, and varying the overlap of the superconductor film portion 108 and the superconductor film portions 106a, 106b changes the capacitance therebetween (such as is well understood by skilled artisans in the general case of parallel plate capacitors). Decreasing the physical overlap of the superconductor film portions 106a or 106b relative to superconductor film portion 108 results in decreasing the capacitance of the variable capacitance portion 104. The lateral movement of the superconductor film portion 108 relative to the superconductor film portions 106a, 106b changes the capacitance of the variable capacitance portion 104, and alters the resonant frequency of the superconductor resonator coil 102.

FIG. 7 shows an alternate embodiment of a tunable superconductor resonator 100 including another embodiment of a variable capacitance portion 104 that includes a mini-electric motor. The variable capacitance portion 104 includes the superconductor film portions 106a and 106b formed on the primary substrate 103, the superconductor film portion 108 formed on the secondary substrate 120, a displaceable mount 750 securing the secondary substrate 120, an arm 756, gear teeth 758 formed on the arm 756, a gear 762, a driver 760, and a power supply 764 to power the driver that drives the gear 762. The arm 756 is constrained to follow a path substantially parallel to arrow 770 by rollers, mounts, bearings, or other such guide devices. In the embodiment of tunable superconductor resonator 100 shown in FIG. 7, the variable capacitance portion 104 displaces the superconductor film portion 108 relative to the superconductor film portions 106a, 106b in a direction generally indicated by arrow 770 to vary the capacitance between the superconductor film portion 108 and the superconductor film portions 106a, 106b.

The displaceable mount 750 supports the secondary substrate 120. The elements that interact to move the displaceable mount 750 include the arm 756, the gear teeth 758, the gear 762, the driver 760, and the power supply 764. All the elements 750, 756, 758, 760, 762, and 764 may be characterized as, and included within, a mini-electric motor 780. As such, the mini electric motor 780 in the embodiment in FIG. 7 acts to displace the secondary substrate 120 relative to the primary substrate 103. This displacement causes a similar change in capacitance as the displacement in the embodiment of movable segment 608 shown in FIG. 6. However, certain embodiments of mini-electric motor 780 as shown in FIG. 7 can provide greater displacements than MEM actuators 612. During operation, the power supply 764 supplies power to rotate the driver 760 and the gear 762 during operation of the micro-electric motor. Rotation of the gear 762 with the gear teeth 758 (the gear teeth are arranged along the arm of 756) transversely drives the arm 756 in a direction parallel to arrow 770. The arm is fixed via the movable mount 750 to the secondary substrate 120. Therefore, rotation of the gear 762 results in translation of the secondary substrate 120 and the attached superconductor film portion 108 in a direction indicated generally by arrow 770.

Many embodiments of tunable superconductor resonators 100 having a variable capacitance portion 104 include a MEM or mini-electric motor device that, when activated, performs tunable filtering or resonator operations. Each MEM or mini-electric motor device can be configured in a variety of ways, and can be easily constructed using silicon and/or other semiconductor technologies. Generally, MEM or mini-electric motor devices are designed for specific applications wherein the secondary substrate 120 can be displaced at a desired distance, and possibly in a desired direction, to provide the dynamic tuning. The above-described embodiments of actuators including MEM or mini-electric motor devices may be integrated in the tunable superconductor resonator 100. In other embodiments, it may be desirable if the MEM or mini-electric motor is constructed from a superconducting material itself. Etching a portion of a superconducting film can produce a freestanding bridge formed from superconducting material that may be configured as a microbridge. These embodiments of tunable superconductor resonators 100 and filters provide for the replacement of bulky actuators by smaller, miniature MEM or mini-electric motor devices, or by a non-magnetic piezoelectric motor.

The above embodiments of tunable superconductor resonator 100 and/or filters using MEM or mini-electric motor devices can be applied to communication frequencies (typically within the 0.5 MHz to 5 GHz range), and/or microwave frequencies (that may extend from 1 GHz to 30 GHz or even higher). These frequencies are often used in space, communication, and military applications. Tunable superconductor resonators 100 (and associated resonator devices) can be made physically smaller and lighter when constructed with MEM or mini-electric motor actuators. Tunable superconductor resonators 100 can therefore be designed to operate at higher frequencies and in smaller packages, and may provide more robust operation. It is also desirable to use MEM or mini-electric motors as dynamic actuators in tunable miniaturized superconductor resonator or filter applications such as in digital cameras.

Another application for the tunable superconductor resonator 100 involves the superconductor resonator coil 102 that could be applied to frequencies utilized in multi-frequency imaging, such as in magnetic resonance imaging (MRI) systems. The tunable superconductor resonator 100 can be used as a MRI probe. In accordance with this embodiment, the resonant frequency of the receiver switches from the magnetic resonance frequency of one particular nuclear spin (e.g., H) to the magnetic resonant frequency of another nuclear spin (e.g., Na) without changing probes. The variable capacitor in the tunable superconductor resonator 100 can be adapted to match the capacitance of the tunable superconductor resonator in the MRI detection circuit to realize electric-controlled matching.

Another embodiment of a tunable superconductor filter (including the tunable superconductor resonator 100) can filter the signal from a conventional receiver or pre-amplifier to get a higher signal-to-noise ratio and lower insertion loss. The tunability of the tunable superconductor filter can be used, e.g., in a base station of a cellular or wireless communication network that requires high sensitivity and swift channel switching. It could also find application in a MRI probe, since such systems require high sensitivity and swift frequency switching to sense resonance signals of nuclei having different spins.

The fabrication of one exemplary embodiment of the tunable superconductor resonator 100 is now described. The substrate may be a two-inch lanthanum aluminate (LAO) wafer substrate having a thickness of about 20 mils. A suitable material for the superconductor is yttrium-barium-copper oxide (YBaCuO) that is deposited as a layer with a thickness of 200 nm on the substrate. The YBaCuO film can be deposited on the substrate at a temperature in the range of 700°-800° C. using laser ablation or sputtering deposition techniques. The LAO substrate and YBaCuO material are available from several commercial vendors, including E. I. DuPont de Nemours and Company. The critical temperature for the YBaCuO material is approximately 93° K. LAO and sapphire can be used as different embodiments of substrate material when YBaCuO forms the superconductor layer structure (considering the high compatibility in lattice matching between the respective crystalline structures of these materials). Other suitable substrate materials include magnesium oxide (MgO) and strontium titanate (SrTiO₃).

An exemplary tunable superconductor resonator 100 or filter can be formed using a YBaCuO film on a clean LAO substrate, effected by a photolithographic patterning process according to the following procedure. First, a suitable photoresist is selectively applied to one side of the substrate. To dry the photoresist, the substrate is typically heated and/or spun, depending on the properties of the photoresist, the substrate, and the film. After the substrate cools, a positive photo mask of the resonator pattern is used to mask the photoresist coated YBaCuO film. The photoresist-coated YBaCuO film is then subjected to exposure to an UV-light through the photo mask. The exposed photoresist on the YBaCuO film is placed in a developer solution. Once developed, the resonator pattern can be realized by selectively etching away the appropriate areas of the YBaCuO film.

The substrate should then be cleaned to remove any remaining photoresist. This can be accomplished by placing the substrate in a solvent. To protect the superconductor structure formed on one side from subsequent etching while any input and output structures are forming on another side, a protective layer of photoresist can be applied, dried, exposed, and developed.

The following embodiment of process can be used to form a contact pad on either side of the substrate. Initially, the side of the substrate to which the contact pad is to be applied is cleaned to remove dirt and any photoresist. Next, photoresist is applied to the substrate (using a negative mask for the contact pads), and the substrate is spun, dried, and exposed. Alternatively, a contact mask pad can be formed from aluminum foil if the foil is carefully applied. The substrate is then developed using known techniques. A metallic coating is formed on the contact areas that were cleared by developing the exposed photoresist by depositing 200 nm of Ag and then 100 nm of Au. A lift-off process can then be employed to remove the unexposed superconductor, such as by using acetone. The resulting structure can be annealed in a pure oxygen environment. Gold wires can be bonded to contact pads using a wire border.

Fabrication of the secondary substrate 120 of the tunable superconductor resonator 100 can be accomplished according to the process described above and connected, or otherwise formed, on the movable end of the actuator according to conventional methods. Tuning a tunable superconductor resonator 100 or filter including a MEM or mini-electric motor actuator uses a relatively small voltage compared with prior-art piezoelectric actuators.

The foregoing disclosure has set forth a variety of dynamically tunable superconductor resonators. These dynamically tunable superconductor resonators may be operated as the only tuning mechanism for a superconductor resonator. Alternatively, these dynamically tunable superconductor resonators may be designed to interact with statically tunable superconductor resonators.

Statically Tunable Superconductor Resonators

Static tuning of certain embodiments of the tunable superconductor resonator 100 involves altering the state of selected portions of the superconductor portions of superconductor films or superconductor traces. This causes a variation in the capacitance of the variable capacitance portion 104, and thereby tunes the resonant frequency of the superconductor resonator 100.

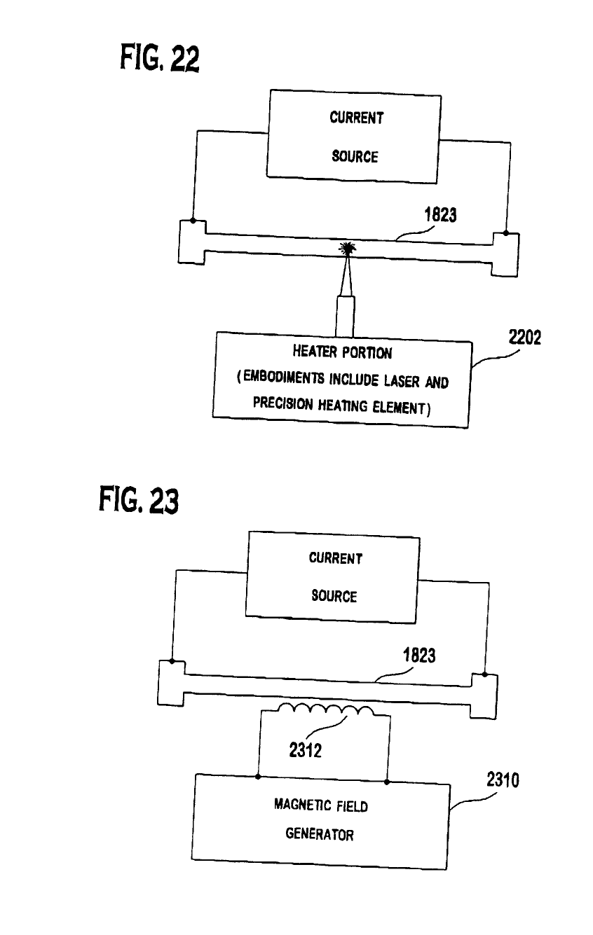

This disclosure focuses on those embodiments of the statically tunable superconductor resonator 100 that are tuned by changing the electric field applied to the selected portions of the superconducting material. The generalized concepts described in these embodiments also pertain to other embodiments of the tunable superconductor resonators 110, as described below, that are tuned by changing the magnetic field as shown in FIG. 23; as well as those embodiments that are tuned by changing the temperature of selected portions of the superconducting material as shown in FIG. 22.

In certain purely statically tuned embodiments of tunable superconductor resonators 100, the static tuning portion is the only tuning portion. In other embodiments of the tunable superconductor resonator 100, the static tuning portion is combined with an additional dynamic tuning portion to tune the tunable superconductor resonator. In another embodiment, either the static tuning portion or the dynamic tuning portion provides a coarse tuning capability while the other tuning portion (i.e., the dynamic tuning or static tuning portion) provides a precise tuning capability.

In some embodiments of the tunable superconductor resonators 100 (either static or dynamic), tuning the resonant frequency of the superconductor resonator coil 102 involves changing the dielectric constant (∈) of the superconducting material, and/or changing the permeability (μ) of the substrate. Altering the dielectric constant (∈) changes the resonant frequency of the tunable superconductor resonator 100 (i.e., tunes the tunable superconductor resonator). By providing a piece of dielectric material, called a ferrite (not shown), proximate to the superconductor resonator coil 102 of the tunable superconductor resonator 100, the dielectric constant (∈) of the superconductor resonator coil 102 can be adjusted to tune the resonant frequency of the tunable superconductor resonator 100. This functionality can be accomplished by changing the permeability (μ) of the ferrite through adjustment of a magnetic field that is applied to the ferrite, and/or by changing the dielectric constant (∈) of the ferrite via adjustment of an applied voltage or current. The ferrite may be located on/in the primary substrate 103, on/in the secondary substrate 120, or at some other position close to either substrate 103, 120. Ferrites are considered as ceramics having magnetic properties. As stated above, an electrical current may be flowed into, or a voltage applied across, this ferrite to change the dielectric constant (∈) of the ferrite.

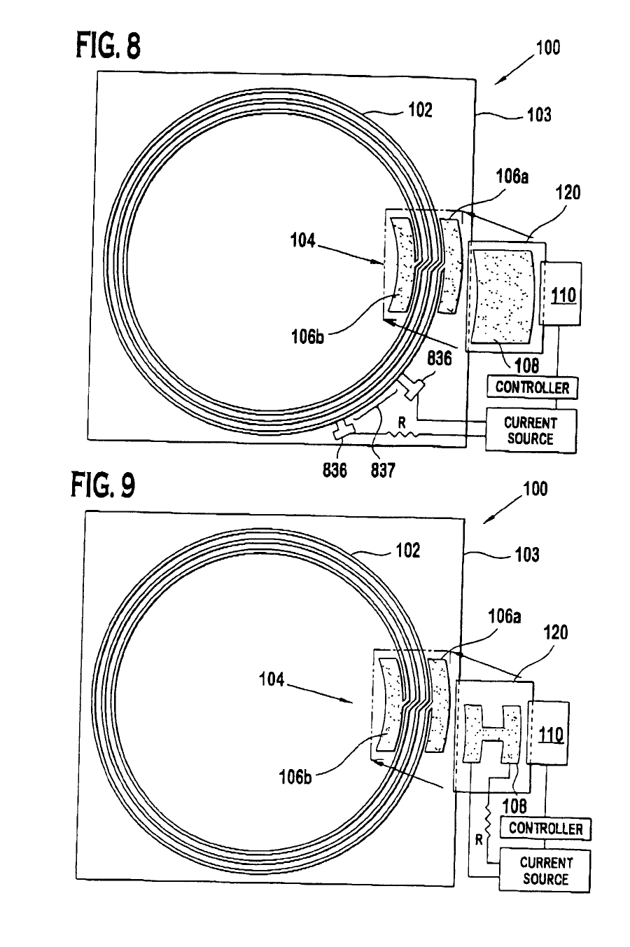

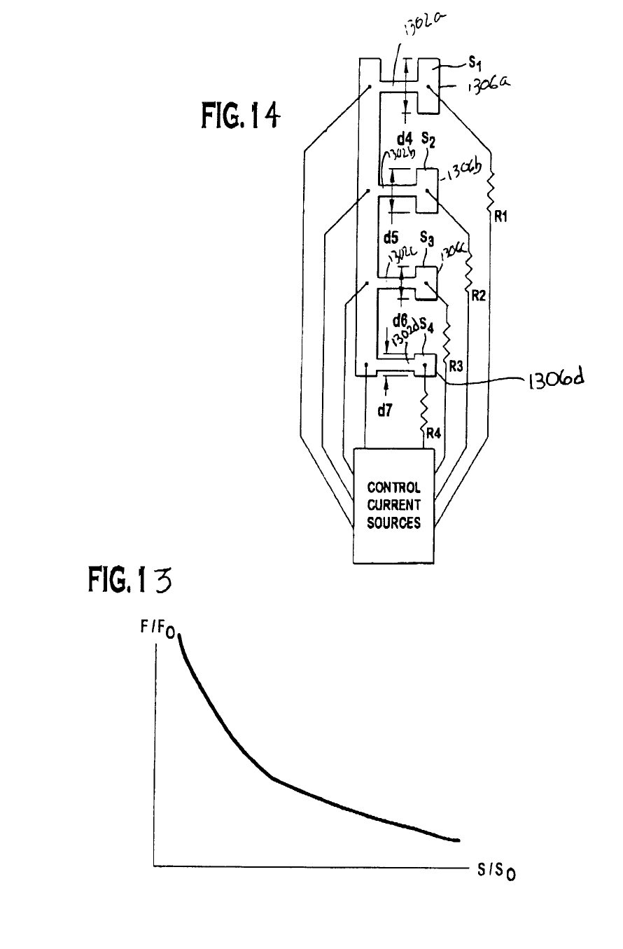

There are a variety of embodiments of statically tunable superconductor resonators 100. In the embodiment of tunable superconductor resonator shown in FIG. 8, a portion of the variable capacitance portion 104 is integrated in the superconductor resonator coil 102. In FIGS. 9 to 14, 15 to 18B, and 20A and 20B, the variable capacitance portion 104 is physically distinct from the superconductor resonator coil 102.

Superconductor Section Integrated in Superconductor Resonator Coil.

FIG. 8 shows one embodiment of the statically tunable superconductor resonator 100 in which the variable capacitance portion 104 may be, at least in part, integrated in the superconductor resonator coil 102 itself. A superconductor section 837 (of the superconductor resonator coil 102) transitions between its normal and superconducting states to tune the resonant frequency of the tunable superconductor resonator 100. A current source 190, under the control of the controller 111, applies a control current to the superconductor section 837 of the superconductor resonator coil 102 (contacts 836 are located on opposite ends of the superconductor section 837). Varying the electric current density flowing through the superconductor section 837 (of the variable capacitance portion 104) tunes the resonant frequency of the superconductor resonator coil 102. The capacitance and the electrical resistance of the superconductor resonator coil 102 changes as the superconductor section 837 transitions between its superconducting and normal states. A relatively high control current is applied through contacts 836 to the superconductor section 837 that can transition the superconductor section 837 from its superconducting state to its normal state, and therefore the superconductor section 837 will have relatively high electric current density J_{O}. When the superconductor section 837 has a high current density J_{O}, the entire superconductor resonator coil 102 will have a relatively low resonant frequency. The resonant frequency of the superconductor resonator coil 102 increases as the superconductor section 837 transitions from its normal state to its superconducting state (and decreases after transitioning from its superconducting state to its normal state). Sufficiently decreasing the control current from the current source 190 through the superconductor section 837 acts to return the superconductor section 837 to its superconducting state. Other methods that can be used to transition the superconductor section 837 (that may be viewed as a converting trace) between its normal and its superconducting states to tune the resonant frequency of the superconductor resonator coil 102 (of the tunable superconductor resonator 100) are within the intended scope of the present invention. Those methods described herein include, e.g., optical heating of the superconductor material or changing the level of the magnetic flux that is applied to the superconductor material as shown respectively in the embodiments of tunable superconductor resonator 100 in FIGS. 22 and 23.

The positioning of pairs of (or multiple pairs of) contacts 836 therefore determine the degree of tunability of the tunable superconductor resonator 100. One superconductor section 837, having a prescribed axial coil length, is illustrated in the embodiment of tunable superconductor resonator shown in FIG. 8. It is envisioned that there may be multiple superconductor sections 837, with each one of the different superconductor sections having a different (or alternatively the same) axial coil length. Alternatively the effective axial coil length of one superconductor section 837 may be effectively changed by, for example, one of the contacts 836 associated with the superconductor section 837 being replaced by multiple contacts 836 that are separated by a single contact by different axial distances along the superconductor resonator coil 102. As such, actuating different sets of contacts provides a length-adjustable embodiment of the semiconductor section 837. By applying control currents to different pairs of contacts 836, superconductor sections 837 with different lengths are transitioned between their normal and superconducting states, thereby tuning the tunable superconductor resonator 100 through different frequency ranges. Tuning the resonant frequency of the tunable superconductor resonator by transitioning the superconductor section 837 between its superconducting state and its normal state is a function of the length of the superconductor section 837. The tuning effect on the resonant frequency of transitioning one superconductor section 837 (between its superconducting and normal states) having a prescribed axial coil length is half the effect of transitioning another superconductor section 837 having twice the prescribed axial coil length 837. Using multiple superconductor sections 837 having different axial coil lengths, where the individual superconductor sections can be individually transitioned, provide a greater range of tunability and/or a more precise tunability of the tunable superconductor resonator 100.

In one embodiment of tunable superconductor resonator 100, certain superconductor sections 837 (only one superconductor section is shown in FIG. 8) may each be configured to have axial coil lengths that are multiples of 2 times the axial coil length of other superconductor sections. For example, one superconductor section 837 may be twice as long along the superconductor resonator coil 102 as another superconductor section 837; four times as long as another superconductor section; and eight times as long as yet another superconductor section 837, etc. Providing selective control of individual superconductor sections 837 having axial coil lengths that incrementally increase by multiples of 2 provides control as specific ones of the individual superconductor sections 837 are transitioned between their normal and superconducting states. This control may be considered as digital control since transitioning of each individual superconductor section between its normal and superconducting states will have an effect on the resonant frequency of the superconductor resonator coil 102 that is a multiple of 2ⁿ, wherein n is a positive integer, of the effect of transitioning other superconductor sections. As such, by selective control of the state of the different superconductor portions, the resonant frequency of the tunable superconductor resonator can be controlled to 2, 4, 8, 16, . . . , 256, etc. equally-separated resonant frequencies. The effect that each superconductor section 837 has on the resonant frequency is a function of the length of the superconductor section.

Superconductor Trace Integrated in Distinct Variable Capacitance Portion

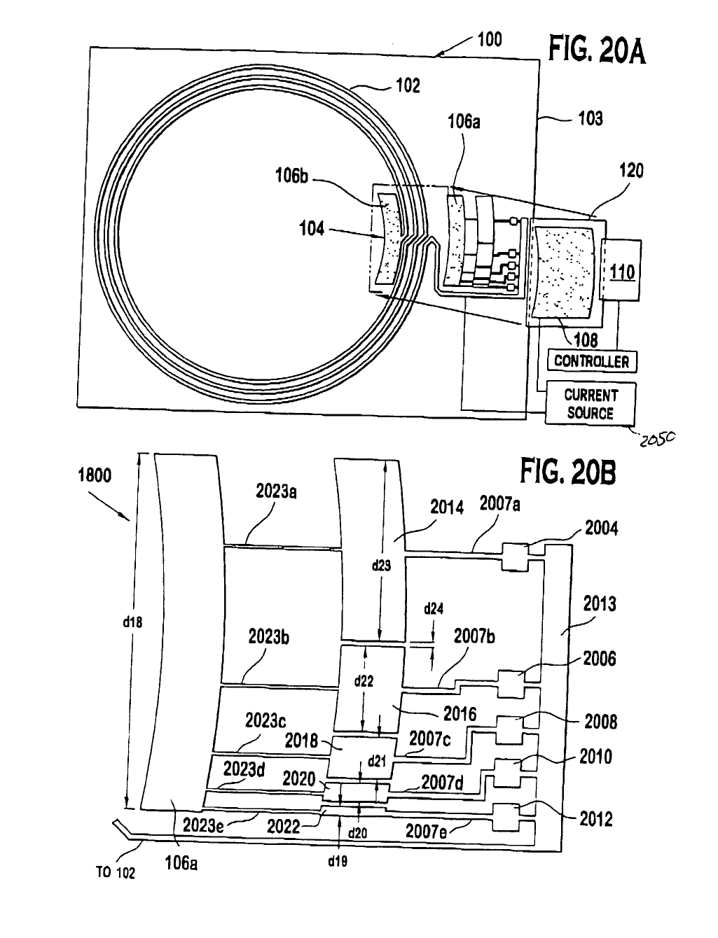

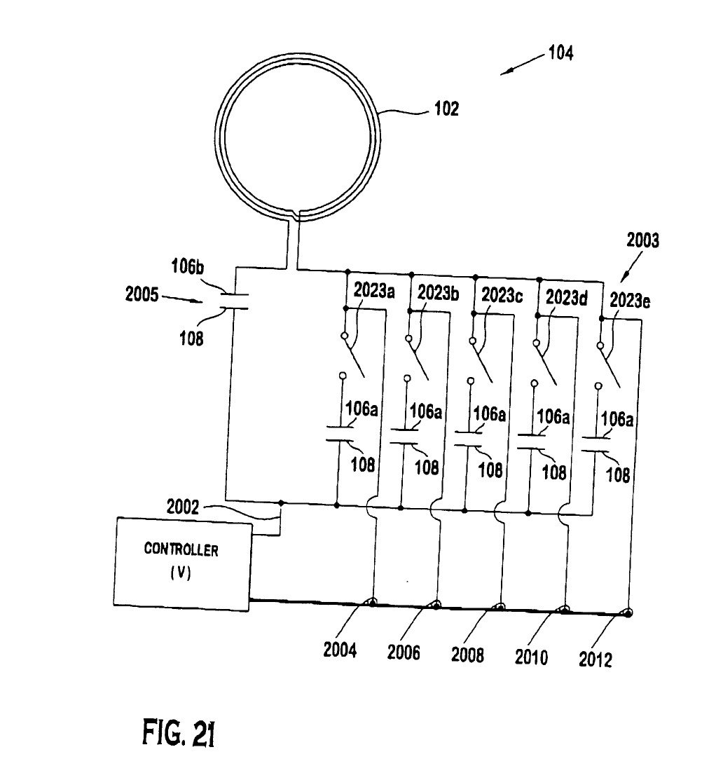

Multiple embodiments of statically tunable superconductor resonators are now described in which the variable capacitance portion that tunes the tunable superconductor resonator is physically separated from the superconductor resonator coil 102. Multiple embodiments of superconductor trace(s), which are often provided with different reference numbers, are described in different embodiments of tunable superconductor resonator in this section. In one set of embodiments of statically tunable superconductor resonator, illustrated in FIGS. 9-11, 14-16, 18A, and 18B, the superconductor traces of the variable capacitor portion are located on the secondary substrate 120. In another set of embodiments of statically tunable superconductor resonator illustrated in FIGS. 20A and 20B, the superconductor trace(s) are located on the primary substrate 103.

Semiconductor Traces Located on Secondary Substrate

FIG. 9 shows one embodiment of a tunable superconductor resonator 100 in which the superconductor traces 1008 of the variable capacitance portion 104 statically tune, but are located on the secondary substrate 120, that is physically separated from the superconductor resonator coil 102. The superconductor traces of the variable capacitance portion control the capacitance of the variable capacitance portion that is capacitively coupled to the superconductor resonator coil. The superconductor traces 1008 are located on the secondary substrate. The tunable superconductor resonator 100 includes the superconductor resonator coil 102, the controller 111, the current source 190, the resistor R, and the variable capacitance portion 104. The variable capacitance portion 104 includes the superconductor film portions 106a, 106b (formed on the primary substrate 103) and a superconductor film portion 108 (formed on the secondary substrate 120). The superconductor film portion 108 includes two superconductor portions 1004 and 1006, and a superconductor trace 1008. The superconductor trace 1008 extends between the superconductor portions 1004 and 1006 to form a generally H-shaped configuration. The current source 190 applies an electric current that flows between the superconductor portions 1004 and 1006 via the superconductor trace 1008. The dimensions (height, thickness, length) of the superconductor trace 1008 relate to the amount of electric current that can flow through the superconductor trace between the superconductor portions 1004 and 1006 at the critical electric current density level of the superconductor material in the superconductor trace 1008. If, for example, the superconductor trace 1008 is made twice as deep while maintaining the same length and height, then twice the electric current (i.e., the same electric current density) can flow through the superconductor trace 1008. Similarly, if the superconductor trace 1008 is made twice as high while maintaining the same thickness and length, then twice the electric current (i.e., the same electric current density) can flow through the superconductor trace.

During operation, the superconductor portion 1004 is positioned relative to (and is capacitively coupled to) the superconductor film portion 106b. During operation, the superconductor portion 1006 is positioned relative to (and is capacitively coupled to) the superconductor film portion 106a. The positioning of the superconductor portion 1004 relative to superconductor film portion 106b partially determines the capacitance between the superconductor film portion 106b and the superconductor portion 1004. The positioning of the superconductor portion 1006 relative to superconductor film portion 106a partially determines the capacitance between the superconductor portion 1006 and the superconductor film portions 106a. The embodiment of statically tunable superconductor resonator 100 shown in FIG. 9 limits any potential electrical interference that may result if potential from the control circuit were applied directly to the superconductor resonator coil 102.

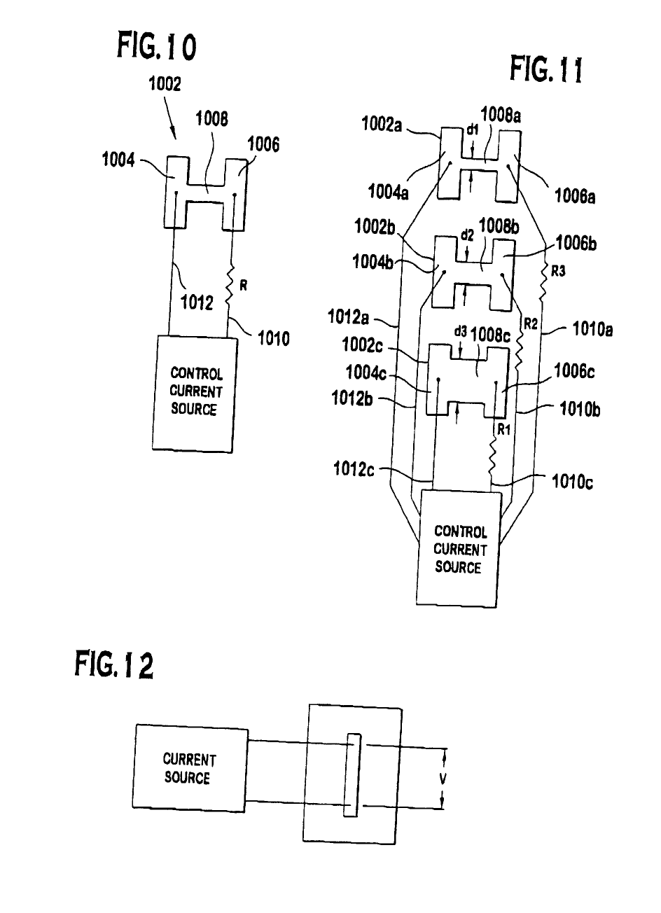

In purely statically tunable superconductor resonators 100 (where there is no dynamic tuning), the secondary substrate 120 remains stationary relative to the primary substrate 103 as portions of the superconductor film portion 108 transition between their superconducting and normal states. Certain embodiments of tunable superconductor resonators 100, however, use a combination of dynamic tuning (as described above) and static tuning. In the superconductor film portion 108 shown in FIG. 10 (which is an expanded view of the superconductor film portion 108 on the secondary substrate 120 shown in FIG. 9) the superconductor trace 1008 is of a relatively narrow thickness and cross sectional area. Applying sufficient control current across the superconductor trace 1008 transitions the superconductor trace from its superconducting state to its normal state. As the superconductor trace 1008 transitions to its normal state, the electrical resistance of the superconductor trace 1008 increases, and the capacitance across each pair of capacitive couplings (between the superconductor portion 1006 and the superconductor film portions 106a, and between the superconductor film portion 106b and the superconductor portion 1004) increases. This change in the capacitances of the variable capacitance portion 104 acts to tune the resonance of the superconductor resonator coil 102 as described herein.

In multiple embodiments of the variable capacitance portion 104, the superconductor film portion 108 has a generally H-shaped configuration as shown in FIG. 9. The H-shaped configuration can be modified, or repeated, to form many different embodiments. The H-shaped configuration determines the change in the capacitance of the variable capacitance portion 104 when the associated superconductor trace transitions between its normal and superconducting states. FIG. 11, for example, shows three modified and operationally associated versions of the superconductor film portion 108, each superconductor film portion is similar to that shown in FIG. 9. In the superconductor film portion 108, there are three superconductor film portions 108a, 108b, and 108c, each of which has a H-shaped configuration. The respective superconductor film portions 108a, 108b, and 108c include respective superconductor portions 1004a, 1004b, and 1004c; respective superconductor portions 1006a, 1006b, and 1006c; and respective superconductor traces 1008a, 1008b, and 1008c. Superconductor trace 1008a extends between superconductor portions 1004a and 1006a. Superconductor trace 1008b extends between superconductor portions 1004b and 1006b. Superconductor trace 1008c extends between superconductor portions 1004c and 1006c.

Superconductor traces 1008a, 1008b, and 1008c each have a similar length and thickness as shown in FIG. 11. The height of respective superconductor traces 1008a, 1008b, and 1008c is shown respectively as d1, d2, and d3. Distance d3 is twice distance d2, and distance d2 is twice the distance d1. Each superconductor film portion 108a, 108b, and 108c as shown in the embodiment of superconductor film portion 108 in FIG. 11, operates similarly to the superconductor film portion 108 as shown in FIGS. 9 and 10 as described above. If similar electric current densities flow across superconductor contacts 1006a, 1006b, and 1006c (that have similar cross-sections), then the electric current density of superconductor trace 1008a is twice that of superconductor trace 1008b and four times that of superconductor trace 1008c because of the relative height dimensions d1, d2, and d3 of respective superconductor traces 1008a, 1008b, and 1008c. Due to the difference in the dimensions d1, d2, and d3 of the respective superconductor traces 1008a, 1008b, and 1008c, for a uniform voltage across each respective pair of superconductor portions 1006a, 1006b, 1006c and superconductor portions 1002a, 1002b, and 1002c, then the electric current density of the superconductor trace 1008a is twice that of the superconductor trace 1008b, and four times that of superconductor trace 1008c. The critical electric current density (the electric current density at which the superconductor material of the superconductor trace transitions between its normal and superconducting state) is equal for each superconductor trace 1008a, 1008b, and 1008c. As such, the electric current level across the superconductor portion 1006a at which the superconductor trace 1008a transitions from its superconducting state to its normal state is half the electric current level across the superconductor portion 1006b at which the superconductor trace 1008b (that has twice the cross-sectional area of 1008a) transitions from its superconducting state to its normal state. Similarly, the electric current level across the superconductor portion 1006b at which the superconductor trace 1008b transitions from its superconducting state to its normal state is half the electric current level across the superconductor portion 1006c at which the superconductor trace 1008c (that has twice the cross-sectional area of 1008b) transitions from its superconducting state to its normal state.

Due to the difference in dimensions d1, d2 and d3 of each respective superconductor trace 1008a, 1008b, and 1008c, those superconductor traces 1008a, 1008b, and 1008c that have a greater cross-area (e.g., have a greater height) will allow a greater electric current to flow therethrough. As more electric current is allowed to pass from the respective superconductor portions 1006a, 1006b, 1006c to the respective superconductor portions 1002a, 1002b, and 1002c, less electric potential will be allowed to build up across these respective pairs of superconductor portions. A lower electric potential across each respective superconductor portion 1006a, 1006b, 1006c and the respective superconductor portion 1002a, 1002b, and 1002c results in a decrease capacitance between each respective superconductor portion 1006a, 1006b, 1006c and the superconductor film portion 106a as shown in FIG. 9. In the embodiment of variable capacitance portion 104 shown in FIG. 11, the resonant frequency of the superconductor resonator coil 102 could then be tuned by different amounts by applying a combination of control current 190 to transition each one of the distinct superconductor traces 1008a, 1008b, and 1008c included in the superconductor film portion 108 between their superconducting and their normal states. This transitioning of the superconductor traces 1008a, 1008b, and 1008c alters the respective capacitance between the respective superconductor portion 1006a, 1006b, 1006c and the superconductor film portion 106a. The dimensions of each superconductor trace 1008a, 1008b, and 1008c correspond to the capacitance that can be established between each respective superconductor portion 1008a, 1008b, 1008c and the superconductor film portion 106a. Since each superconductor portion 108a, 108b, 108c can establish a capacitive coupling that corresponds to the cross-section area (i.e., height) of the respective superconductor trace 1008a, 1008b, and 1008c; the heights of d1, d2 and d3 increase by respective multiples of 2; and the associated capacitances therefore decrease by multiples of two. As such transitioning the superconductor trace 1008a has twice the effect on the resonant frequency of the superconductor resonator coil 102 as transitioning superconducting trace 1008b (and four times the effect on the resonant frequency as transitioning superconducting trace 1008c). As such, digital control is provided since transitioning of each individual superconductor trace between its normal and superconducting states will have an effect on the resonant frequency of the superconductor resonator coil 102 that is a multiple of 2ⁿ, wherein n is a positive integer, of the effect of transitioning other superconductor traces. As such, by selective control of the state of the different superconductor traces, the resonant frequency of the tunable superconductor resonator can be controlled to 2, 4, 8, 16, . . . , 256, etc. equally-separated resonant frequencies.

The resonant frequency of the superconductor resonator coil 102 is related, and may be modeled as proportional, to the cross-sectional area of the superconductor film portion 108. To test the critical electric current for a superconductor trace using a set-up as shown in FIG. 12, equation 1 applies:

J_{C}=Ic/A. (equation 1)

Where Ic equal the electric current flowing through the superconductor trace, and A equals the area of the superconductor trace.

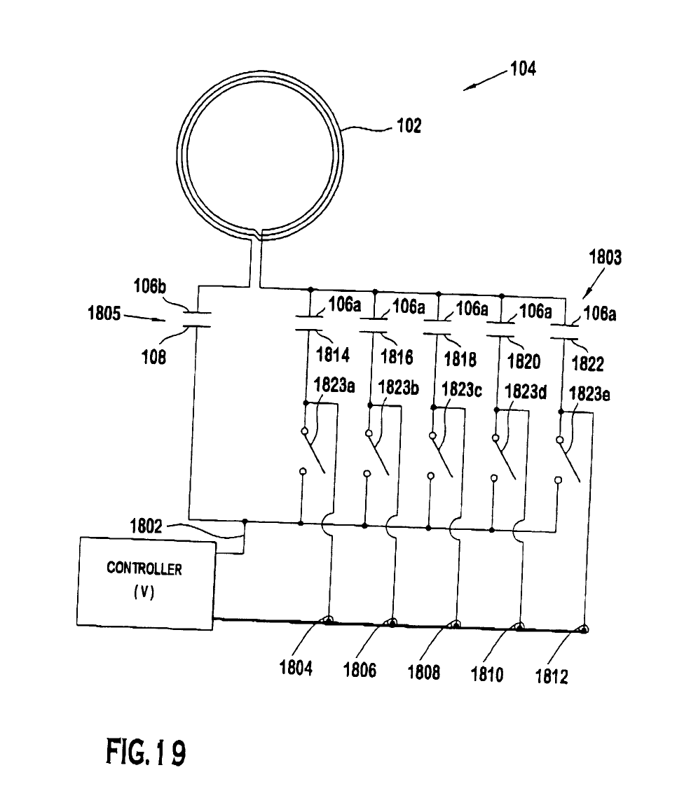

FIGS. 14, 15, 16, 18A, and 18B show different embodiments of tunable superconductor resonator 100 in which the dimensions (e.g. areas) of all the superconductor traces are substantially equal. In these embodiments of tunable superconductor resonator 100, the superconductor traces are located on the secondary substrate 120. An equivalent electronic circuit diagram to the circuits shown in FIGS. 14, 15, 16, 18A, and 18B is shown in FIG. 19. These embodiments of tunable superconductor resonator 108 include the superconductor film portion 108 that is segmented to include multiple superconductor film portions 108d, 108e, and 108f (see FIG. 18B). Superconductor portions B, C, D are layered to form the superconductor film portion 108 on a side of the secondary substrate 120. The superconductor film portion formed on the secondary substrate 120 include electric pads V_{A}, V_{B}, V_{C}, and V_{D}, the superconductor portion A; the superconductor portions B, C, D; the superconductor traces 1302a, 1302b, 1302c; and the superconductor portion 1002. Multiple embodiments of tunable capacitance portion 104 are shown in FIGS. 14-16, 18A, and 18B to demonstrate the variety of layout configurations that are included in this disclosure.

The superconductor portion A is electrically connected to the superconductor portion 1002, and forms a portion of a return loop so electric current can flow from the superconductor portion 1002 to the current source 190. The superconductor portion 1002 is capacitively coupled to superconductor film portion 106b as a result of their relative positions, and there is no permanent electrical conductor formed therebetween. Superconductor contact portions “B”, “C”, and “D” are capacitively coupled to, but do not physically contact, the superconductor film portion 106a.

Superconductor film portion 108d includes the superconductor portions B and 1002, and the superconductor trace 1302a. The superconductor trace 1302a extends between the superconductor portions B and 1002. Superconductor film portion 108e includes the superconductor portions C and 1002, and the superconductor trace 1302b. The superconductor trace 1302b extends between the superconductor portions 1002 and C. Superconductor film portion 108f includes the superconductor portions 1002 and D, and the superconductor trace 1302c. The superconductor trace 1302c extends between the superconductor portions 1002 and D. The electrical resistances of resistors R₁, R₂, and R₃ may, or may not, have equal electrical resistance. Depending on the state of superconductor trace 1302a, the current source 190 directs electric current via a resistor R2 to the superconductor portion B, through the superconductor trace 1302a, via the superconductor portion 1002, and back to the current source 190. Depending on the state of superconductor trace 1302c, the current source 190 directs electric current via a resistor R3, to the superconductor portion C, via the superconductor trace 1302b, through the superconductor portion 1002, and back to the current source 190. The current source 190 directs electric current via a resistor R4, to the superconductor portion D, via the superconductor trace 1302c, and the superconductor portion 1002, back to the current source 190.

Each superconductor portion B, C, and D; and 1002 may be configured as rectangular, circular, or some other shape. Each superconductor portions B, C, and D is capacitively coupled to the superconductor film portion 106a (see FIG. 9). The superconductor film portions 106a and 106b are electrically connected to opposite ends of the superconductor resonator coil 102. The superconductor portion 1002 is capacitively coupled to the superconductor film portion 106b. Superconductor traces 1302a, 1302b, and 1302c, connect the superconductor portion 1002 to its associated superconductor portion B, C, and D. The area ratios of the respective portions B, C, and D, are S₁, S₂, and S₃.

The length and thickness of superconductor traces 1302a, 1302b, and 1302c are substantially equal. Superconductor portion B has a height d4, superconductor portion C has a height d5, and superconductor portion D has a height d6. The height d4 of superconductor portion B is twice the height d5 of superconductor portion C, and four times that of the height d6 of superconductor portion D. When a substantially equal electric current density flows across respective superconductor portions B, C, and D, because the height d4 of the superconductor trace 1302a is greater than the height d5 of the superconductor trace 1302b (and the height d5 is greater than the height d6 of the superconductor trace 1302c), then the electric current density in superconductor trace 1302a is approximately twice the electric current density in superconductor trace 1302b (and four times the electric current density in superconductor trace 1302c) since the superconductor traces 1302a, 1302b, and 1302c have equal cross-sectional areas.

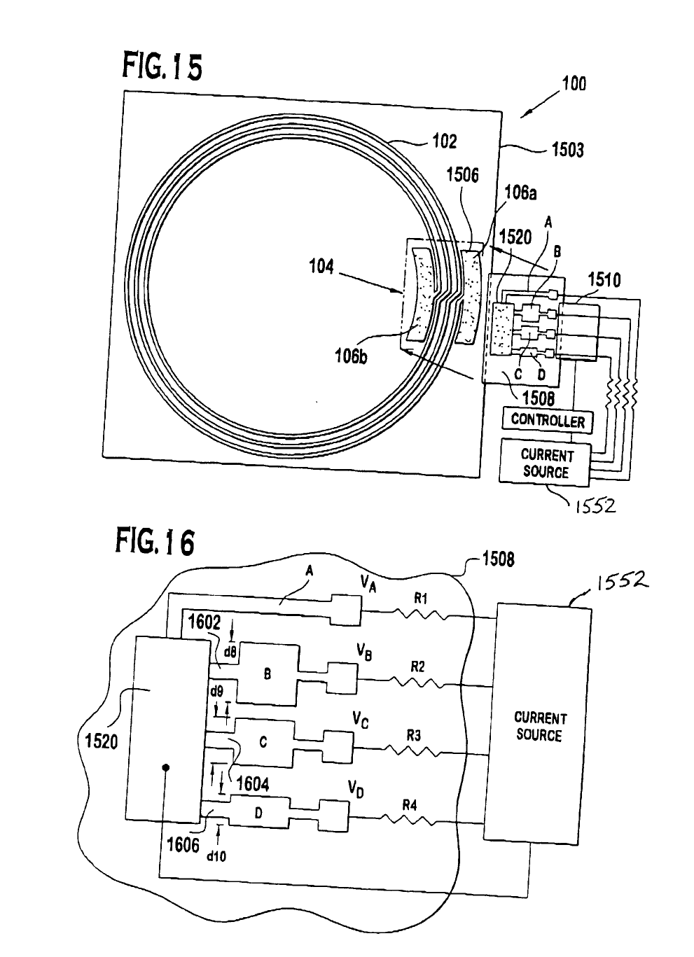

By using the embodiments of superconductor film portion 108 as shown in FIG. 14, 16 and 18B within the tunable superconductor resonator 100, transitioning each one of the respective superconductor traces 1302a, 1302b, and 1302c between its superconducting and normal state results in a different change in resonant frequency of the superconductor resonator coil 102 of the tunable superconductor resonator 100. The effect that each superconductor trace 1302a, 1302b, and 1302c has on the resonant frequency of the superconductor resonator coil 102 is a function of the respective cross sectional areas S₁, S₂, and S₃ of the respective superconductor portions B, C, and D. Since the cross sectional area S₁ of the superconductor portion B is twice the cross sectional area S₂ of the superconductor portion C, and four times the cross-sectional area S₃ of the superconductor portion D; twice as much capacitance can exist in a capacitive coupling between superconductor portion B and the superconductor film portion 106a (shown in FIGS. 15 and 18A) as between the superconductor portion C and the superconductor film portion 106a. Similarly, four times as much capacitance exists in the capacitive coupling between superconductor portion B and the superconductor film portion 106a as between the superconductor portion D and the superconductor film portion 106a.

During operation as shown in FIGS. 14, 15, 16, 18A, and 18B, the superconductor portion 1002 substantially overlies the superconductor film portion 106b, while the superconductor portions B, C, and D substantially overlie the superconductor film portion 106a. The superconductor trace 1302a as shown in FIGS. 14, 15,16, 18A, and 18B extends from the superconductor portion B to superconductor portion 1002. The superconductor trace 1302b extends from the superconductor portion C to the superconductor portion 1002. The superconductor trace 1302c extends from the superconductor portion D to the superconductor portion 1002. Applied electric current flows from the current source 190, via resistor R2, to the electric contact V_{B}, to the superconductor portion B and the superconductor trace 1302a, to the superconductor portion 1002, to superconductor portion A, to electric contact V_{A} via resistor R1, and back to the current source 190. Applied electrical current flows from the current source 190, via resistor R3, to the electric contact V_{C}, via superconductor portion C, and via superconductor trace 1302b, to the superconductor portion 1002, to the superconductor portion A, to the electric contact V_{A} via the resistor R1, and back to the current source 190. Electricity applied from the current source 190 flows via resistor R4, to the electric contact V_{D} via superconductor portion D, and via the superconductor trace 1302c, to the superconductor portion 1002, to the superconductor portion A, to the electric contact V_{A} via the resistor R1, and back to the current source 190.

When the respective superconductor traces 1302a, 1302b, and 1302c are in their respective superconducting states, electric current flowing from the respective superconducting portions B, C, and D to the superconductor portion 1002 has a greater tendency to flow through the respective superconductor traces 1302a, 1302b, and 1302c. However, when any of the superconductor traces 1302a, 1302b, or 1302c transitions from its superconducting state to its normal state, the electrical resistance of that superconductor trace increases. By increasing the electrical resistance of that respective superconductor trace 1302a, 1302b, or 1302c, electric current flowing from the respective superconductor portion B, C, or D to the superconductor portion 1002 is limited and a greater electric potential is created. In the embodiment of superconductor film portion 108 shown in FIGS. 14, 15, and 18A, the increase in potential also enhances the “parallel plate” capacitance between the respective superconductor portions B, C, and D and the superconductor film portion 106a. Such an increase in capacitance between each superconductor portion B,C, and D and the superconductor portion 1002 affects the resonant frequency of the superconductor resonator coil 102.

If the same electric current density flows across a superconductor portion with a larger cross-sectional area than flows across a superconductor portion with a smaller cross-sectional area (e.g., superconductor portion B has a larger cross-sectional area than superconductor portion C), then a proportionately greater electric current flows across the superconductor portion with the greater area. Similarly, a proportionately greater capacitance will exist between the larger superconductor portion B and superconductor film portion 106a than exists between the smaller superconductor portion C and the superconductor film portion 106b.

If the superconductor traces 1302a, 1302b, and 1302c transition between their superconducting states and their normal state, then the overall capacitance of the variable capacitance portion varies. The amount of capacitance variation is a factor of the different dimensions of the traces and/or portions. The resonant frequency of the tunable superconductor resonator 100 can be determined using the following equations:

$$\begin{matrix}{f}_{i} = \frac{1}{2 π \sqrt{{LC}_{i}}} ∝ \frac{1}{2 π \sqrt{{LS}_{i}}} \\ \frac{f}{{f}_{o}} = \sqrt{\frac{{s}_{o}}{{s}_{i}}} \\ f = {f}_{o} \sqrt{\frac{{s}_{o}}{{s}_{i}}}\end{matrix}$$

For S₁=S₀/2

S₂=S₀/4

S₃=S₀/8

and

S_{N}=S₀/2N

we have

fₘₐₓ=2^{n/2} f₀

Δf=(2^{n/2}−2^{n-1/2})f=f₀2^{(n-1)/2}fₒ (increase step)

$$Δ f = \{ \sqrt{\frac{1}{1 - ( \frac{1}{2 n} )}} - 1 \} {f}_{o} ≅ \frac{1}{{2}^{( n + 1 )}} {f}_{o}$$

For Fₒ Mhz and n=5,

$$Δ f = \frac{7 Mhz}{{2}_{6}} = 0.1 M$$

with range from f₀ to 2^{(n/2)} f₀.

Where L equals the inductance, Lᵢ equals the capacitance between the specific superconductor portions, Sᵢ equals the area of the superconductor portions B to D, and F equals the resonant frequency of the tunable superconductor resonator 100. These equations apply for f₀=7 Mhz and n=5, f=with the frequency range from f₀ to (2^{n/2})fₒ.

Superconductor portions, such as A, B, C, D, and 1002 each may include Au, Ag, or an alloy thereof, for current control. A superconductor trace inductively couples superconductor portion 1002 to each respective superconductor portion B, C and D. The length of the superconductor trace is selected depending on the control current and thickness of the superconductor film portion The superconductor traces are each referred to as a “superconductor switching path”.

Almost all of the capacitance C, produced by the varying capacitive portion is calculated relative to FIG. 15 as:

Where C is the total capacitance, and Cᵢ is the capacitance associated with

$$\frac{1}{C} = \frac{1}{{C}_{A}} + \frac{1}{{C}_{B} + {C}_{C} + {C}_{D}}$$

superconductor portion i. Additional capacitance may result. The central voltage applied across superconductor portions B, C, and D is initially set low. If there are more than three superconductor portions positioned proximate to superconductor portion 1002, modified equations incorporate the capacitance of the different superconductor portions.

$$\begin{matrix}C = \frac{{C}_{A} + {C}_{B} + {C}_{C} + {C}_{D}}{{C}_{A} ( {C}_{B} + {C}_{C} + {C}_{D} )} \\ \frac{{f}_{i}}{{f}_{o}} = \sqrt{\frac{{C}_{o}}{{C}_{i}}}\end{matrix}$$

Where f₀ is the total frequency and fᵢ is the frequency of superconductor portion i. In one embodiment, using the superconductor material YBCO, the control current density is set above Jc=1×10⁶ A/cm².

FIGS. 14, 15, 16, 18A, 18B, and 19 should be viewed and considered together. The superconductor portion 1002 is deposited as a continuous member. The superconductor portion 1002 connects to an electric contact V_{A}, and forms a portion of an electrical return circuit to the current source 190.

During operation of the embodiment of tunable superconductor resonator 100 shown in FIGS. 14, 15, 16, 18A, and 18B, the first superconductor portion 1803 is positioned adjacent to the superconductor film portion 106a. This relative positioning between the first superconductor portion 1803 and the superconductor film portion 106a provides a respective capacitive coupling C19a, C19b, and C19c, (shown in FIG. 19) between each respective superconductor portion B, C, and D and the superconductor film portion 106a. The capacitances of capacitive couplings C19a, C19b and C19c each decrease successively by a factor of two, based on the respective decreasing areas of B, C, and D. Additionally, the second superconductor portion 1002 is adjacent to the superconductor film portion 106b, and forms a capacitive coupling C19f with superconductor film portion 106b. The superconductor resonator coil 102 extends between the superconductor film portion 106a and the superconductor film portion 106b, and is typically of the embodiments shown in FIG. 1 or 2, but alternatively may be in any other superconductor resonator coil configuration. In tunable superconductor resonators that are both dynamically and statically tunable, the secondary substrate 120 can be displaced relative to the primary substrate 103 using MEMs, mini-electric motors, and the like (as described) to provide the dynamic tuning.

There are two potential electric paths between each one of respective superconductor portions B, C, and D and the superconductor portion 1002 involving the respective superconductor traces 1302a, 1302b, and 1302c as shown in FIGS. 14, 16, and 18B. The amount of electric current flowing through each relative electric path depends on whether each respective superconductor trace 1302a, 1302b, and 1302c is in its normal or superconducting states. The first electric path extends from the current source 190 via the respective resistors R2, R3, and R4 to the respective superconductor portions B, C, and D; then to the respective superconductor traces 1302a to 1302c (that occurs when an optical functionality switch equated to each respective superconducting trace is “closed”, such as when the superconductor trace in its superconducting state) directly to the second superconductor portion 1002; and then via the resistor R2 back to the current source 190.

The second electric path extends from the current source 190 via the respective resistors R2, R3, and R4, to the respective superconductor portions B, C, and D; via the respective capacitive couplings C19a, C19b, and C19c, to the capacitively coupled superconductor film portion 106a; then via the superconductor resonator coil 102 as shown in FIG. 18A to the superconductor portion of the superconductor film portion 106b; then via the capacitive coupling C19f (shown in FIG. 19) to the second superconductor portion 1002, and then via the resistor R1 back to the current source 190. Some of the control current from the current source 190 will be shunted to flow through the first current path to control the resonant frequency for RF (or AC) signals as dictated by the current that flows through the second path.

As shown in FIG. 18B, each electric contact V_{B}, V_{C}, and V_{D} is electrically connected with a respective electrical conductor 1807 to one of the respective superconductor portions B, C, and D. Each electric conductor 1807 is sufficiently large as to not limit the electric current that flows from the respective electric contacts V_{B}, V_{C}, and V_{D} to the respective superconductor portions B, C, and D. The level of electrical current applied to the superconductor trace B, C, and D controls whether the superconductor material in each respective superconducting trace is in its superconducting state or in its normal state (depending on whether the electrical current exceeds the critical value). The capacitance of each capacitive coupling C19a, C19b, and C19c is associated with its respective superconductor trace 1302a, 1302b, and 1302c (as shown in FIG. 19). The greater the cross-section area (e.g., height or thickness) of any particular superconductor portion B, C, and D, the greater the associated capacitance that can exist in the respective capacitive coupling C19a, C19b, and C19c associated with that superconductor portion. Depending upon which superconductor traces 1302a to 1302c are changed from their superconducting to their normal states, the amount of capacitance provided by the variable capacitance portion 104 can be precisely controlled. Actuating, in turn, the capacitive couplings C19a, C19b, and C19c (whose capacitances decrease sequentially by multiples of two) thereby controls the capacitance of the variable capacitance portion 104 as shown in FIG. 18A, and thereby allows control of the resonant frequency of the superconductor resonator coil 102 of the tunable superconductor resonator 100.

Providing a tunable superconductor resonator having a plurality of superconductor traces 1302a, 1302b, and 1302c that each have varying dimensions can provide the superconductor resonator coil 102 with both de-tune and auto-tune functions. These superconductor traces 1302a, 1302b, and 1302c provide the function of the variable capacitor for the variable capacitive portion 104 that can be altered to tune the frequency of the tunable superconductor resonator 100 in a substantially digital fashion. For example, transitioning the superconductor trace 1302a between its superconducting and normal states has twice the effect on the resonant frequency of the superconductor resonator coil 102 as transitioning the superconductor trace 1302b between its superconducting and normal states since the area of the superconductor portion B is twice the area of superconductor portion C (and therefore creates twice the capacitive coupling with the superconductor film portion 106a as a result of parallel plate capacitor equations). Similarly, transitioning the superconductor trace 1302b between its superconducting and normal states has twice the effect on the resonant frequency of the superconductor resonator coil 102 as transitioning the superconductor trace 1302c between its superconducting and normal states since the area of the superconductor portion C is twice the area of superconductor portion D (and therefore forms twice the capacitive coupling with the superconductor film portion 106a as a result of parallel plate capacitor equations). Such tuning the resonant frequency of the superconductor resonator coil 102 by frequencies that are multiples of 2ⁿ, wherein n is a positive integer, provides digital control. As such, by selective control of the state of the different superconductor traces, the resonant frequency of the tunable superconductor resonator can be controlled to 2, 4, 8, 16, . . . , 256, etc. equally-separated (e.g., digital) resonant frequencies.

Superconductor Traces Located on Primary Substrate

FIGS. 20A and 20B show another embodiment of tunable superconductor resonator 100 including a plurality of superconductor traces 2023a, 2023b, 2023c, 2023d, and 2023e that are layered on the primary substrate 103. This embodiment differs from the embodiments of tunable superconductor resonator 100 shown in FIGS. 14, 15, 16, 18A and 18B in that the superconductor traces 2023a to 2023e are layered on the primary substrate 103 (instead of the secondary substrate 120). FIG. 21 shows an equivalent electrical circuit to that shown in FIGS. 20A and 20B.

As shown in FIG. 20B, on the primary (non-movable) substrate 103, each electric contact 2004, 2006, 2008, 2010, and 2012 electrically connects to respective superconductor portion 2014, 2016, 2018, 2020, and 2022 via respective electrical conductors 2007a to 2007e. All electric contacts 2004, 2006, 2008, 2010, and 2012 also electrically connect to a common electric junction 2013. One connection of the common electric junction 2013 electrically connects to one end of the superconductor resonator coil 102, and another connection connects to the common electric junction 2013. One end of the controllable current source 190 shown in FIG. 20A attaches to each one of the electric contacts 2004, 2006, 2008, 2010, and 2012 via common electric junction 2013. Another end of the controllable current source 190 electrically connects to the superconductor film portion 108 as shown in FIG. 20A. Each one of the superconductor portions 2014, 2016, 2018, 2020, and 2022 is electrically connected to the superconductor film portion 106a by a respective superconductor trace 2023a, 2023b, 2023c, 2023d, and 2023e.

FIG. 20A shows the superconductor film portion 106a layered adjacent to, and connected by superconductor traces 2023a, 2023b, 2023c, 2023d, and 2023e (shown in FIG. 20B) to a superconductor portion 2003. The superconductor portion 2003 is divided into a plurality of superconductor portions 2014, 2016, 2018, 2020, and 2022. The width (taken in the horizontal direction in FIG. 20B) of each of the superconductor portions 2014, 2016, 2018, 2020, and 2022 is substantially equivalent. The height of each superconducting portion 2014, 2016, 2018, 2020, and 2022 (shown respectively as d9, d10, d11, d12 and d13) is twice the height of the superconductor portion below it as shown in FIG. 20B. As such, the area of each superconductor portion 2014, 2016, 2018, 2020, and 2022 (shown respectively as s6, s7, s8, s9, and s10) has twice the area of the respective downwardly adjacent superconductor portion 2016, 2018, 2020, and 2022. Since the areas S6, S7, S8, S9, and S10 of each respective superconductor portion 2014, 2016, 2018, 2020, and 2022 are each twice the area of the downwardly adjacent superconductor portion, the amount of capacitance that can be altered (as the respective superconductor traces 2023a, 2023b, 2023c, 2023d, and 2023e are transitioned between their normal states and their superconducting states) is twice the capacitance of the downward adjacent superconductor trace. [Drs. Gao and Ma: Don't the heights of areas 2023a to 2023e have to be doubled to double the capacitance between 106a and 108?]

In the embodiment of variable capacitance portion 104 shown in FIG. 20A (similar to those shown in FIGS. 11, 14, 15, and 18A), transitioning the superconductor traces between their normal and superconducting states can alter the capacitance of the variable capacitance portion 104, as well as the resonant frequency of the tunable superconductor resonator 100, by different amounts.

During operation of the tunable superconductor resonator 100, the superconductor film portion 108 is proximate to both the superconductor film portions 106a and 106b. The superconductor resonator coil 102 that connects between the superconductor film portion 106a and the superconductor film portion 106b may be configured as shown in FIG. 1 or 2.

In the embodiment of tunable superconductor resonator shown in FIGS. 20A, 20B, and 21, the superconductor film portion 106a is not directly electrically connected to the superconductor resonator coil 102. However, capacitance is established from a capacitive coupling between the superconductor film portion 108 and the superconductor film portion 106a, to the respective superconductor portions 2014, 2016, 2018, 2020, or 2022 via the respective superconductor trace 2023a, 2023b, 2023c, 2023d, or 2023e to the common electric junction 2013 to the superconductor resonator coil 102 (especially when any one of the respective superconductor traces 2023a to 2023e is in its superconducting state).

The embodiment of the tunable superconductor resonator 100 shown in FIGS. 20A, 20B and 21 (as with the other embodiments of tunable superconductor resonator) is tuned by adjusting the capacitance of the variable capacitance portion 104 that is electrically coupled to the resonator coil 102. Changing the capacitance of the variable capacitance portion 104 alters the resonant frequency of the superconductor resonator coil 102. A first electric path associated with the tunable superconductor resonator 100 extends from the current source 190 via each of the electric contacts 2004, 2006, 2008, 2010, and 2012; via the common electric junction 2013 to the superconductor resonator coil 102. After the electric current passes through the superconductor resonator coil 102, the electric current continues to pass to the superconductor film portion 106b; which, in turn, is capacitively coupled to the superconductor film portion 108. The superconductor film portion 108 is, in turn, electrically connected to the current source 190.

A second electric path associated with the tunable superconductor resonator extends from the current source 190 to each of the electric contacts 2004, 2006, 2008, 2010, and 2012, and flows through respective electric conductors 2007a, 2007b, 2007c, 2007d and 2007e; to the respective superconductor portions 2014, 2016, 2018, 2020, and 2022; via the respective superconductor traces 2023a, 2023b, 2023c, 2023d, and 2023e; via the superconductor film portion 106a. The superconductor film portion 106a is capacitively coupled to the superconductor film portion 108. The superconductor film portion 108 is electrically connected to the current source 190.

When any one of the superconductor traces 2023a to 2023e is in its superconducting state, the potential of the associated superconductor portion 2014, 2016, 2018, 2020, and 2022 is altered. This variation in potential occurs as a result of a change in the capacitance of the superconductor film portion 106a, that is respectively coupled to superconductor film portion 108 (see FIG. 20A). There is a greater electrical resistance between the respective superconductor portions 2014, 2016, 2018, 2020, and 2022 via the respective superconductor traces 2023a, 2023b, 2023c, 2023d, and 2023e to the superconductor film portion 106a when any one of the respective superconductor traces 2023a to 2023e is in its individual non-superconducting (i.e., normal) state. There is a lesser electric resistance through the superconductor resonator coil 102 (the electric current is not shunted through the superconductor traces 2023a to 2023e) when any one of the respective superconductor traces is in its respective non-superconducting (i.e., normal) state. This variation of capacitance alters the resonant frequency of the superconductor resonator coil 102.

FIG. 21 represents an equivalent circuit to the tunable superconductor resonator 100 of FIG. 20A. Each one of the superconductor traces 2023a to 2023e act as a switch that “opens” or “closes” to control whether a portion of the capacitive coupling (between the superconductor film portion 106a and superconductor film portion 108) is electrically coupled to tunable superconductor resonator via that switch. The superconductor switches represented by the superconductor traces 2023a to 2023e are turned on or off by controlling the state (superconducting or normal) of the superconductor traces 2023a to 2023e. Changing the state of the switches (functionally formed from the superconductor traces 2023a to 2023e) changes the capacitance that is connected to the superconductor resonator coil 102 via a portion of the tunable superconductor portion 104 (associated with that respective superconductor trace 2023a to 2023e), which in turn alters the resonant frequency of the superconductor resonator coil 102. As such, controlling the state of each superconductor trace 2023a to 2023e determines the capacitance of the variable capitance portion 104.

Each superconductor portion 2014, 2016, 2018, 2020, and 2022 is electrically connected by an electrical connector 2007a to 2007e to its respective electric contact 2004, 2006, 2008, 2010, or 2012. The electrical current density that is applied to each superconductor trace 2023a to 2023e determines whether the superconductor trace will be in its superconducting state or its normal state. The greater the cross sectional area of the superconductor portion 2014, 2016, 2018, 2020, and 2022, the greater the capacitance associated with the respective superconductor trace 2023a, 2023b, 2023c, 2023d, and 2023e to the superconductor film portion 106a, 106b (when the superconductor portion is in its superconducting state or normal state) [Can we prove this statement? Do 2023a to 2023e act as a “throat” to limit the capacitance?]. Each superconductor portion 2014, 2016, 2018, 2020, 2022 has twice the cross-sectional area of the superconductor portion below it. Therefore, the electrical capacitance associated with the superconductor portion 2014 is twice the capacitance associated with the superconductor portion 2016; four times the capacitance associated with the superconductor portion 2018, and eight times the capacitance associated with the superconductor portion 2020, and sixteen times the capacitance associated with the superconductor portion 2022.

As such, controlling the states (normal or superconducting) of each one of the superconductor traces 2023a, 2023b, 2023c, 2023d, and 2023e individually can provide a precise control of the capacitance of the variable capacitance portion 104 in a substantially digital fashion. Being able to digitally control the capacitance of the variable allows digital control of the resonant frequency of the tunable superconductor resonator 100.As such, digital control is provided since transitioning of each individual superconductor trace between its normal and superconducting states will have an effect on the resonant frequency of the superconductor resonator coil 102 that is a multiple of 2ⁿ, wherein n is a positive integer, of the effect of transitioning other superconductor traces.

FIG. 21 shows an equivalent electrical diagram for the tunable superconductor resonator 100 shown in FIG. 20A. One difference between the equivalent electrical circuit diagram shown in FIG. 19 and the equivalent electrical circuit diagram shown in FIG. 21 involves the attachment location of the superconductor traces. In the FIG. 19 embodiment, opposed ends of the superconductor traces 1302a, 1302b, 1302c, 1302d, and 1302e are electrically connected between the respective superconductor portions B, C, D, E, and F, and the superconductor portion 1002. In the FIG. 21 embodiment, the superconductor traces 2023a, 2023b, 2023c, 2023d, and 2023e are electrically connected, between the superconductor film portion 106a and the respective superconductor portions 2014, 2016, 2018, 2020, and 2022. When the superconductor traces 2023a, 2023b, 2023c, 2023d, and 2023e are in their respective superconducting states, the superconducting traces 2023a to 2023e act as an open circuit.

Both the superconductor trace 1302a, 1302b, 1302c, 1302d, and 1302e shown in FIG. 19 and the superconductor traces 2023a, 2023b, 2023c, 2023d, and 2023e shown in FIG. 21 can be configured to control the capacitance of the variable capacitance portion 104 that is electrically coupled to the superconductor resonator coil 102. The material forming the superconductor traces therefore can be deposited on either the primary substrate 103 or the secondary substrate 120. In one embodiment described herein, adjacent superconductor traces 2023a, 2023b, 2023c, 2023d, and 2023e control the amount of capacitance in the variable capacitance portion (often by some integer multiple of 2). As such, control of the different ones of the superconductor traces may provide a substantially digital control. For instance, transitioning the superconductor trace 2023a between its normal and its superconducting state has twice the affect on the variation of the resonant frequency as would transitioning the adjacent superconductor trace 2023b between its normal and superconducting states. As such, digital control is provided since transitioning of each individual superconductor trace between its normal and superconducting states will have an effect on the resonant frequency of the superconductor resonator coil 102 that is a multiple of 2ⁿ, wherein n is a positive integer, of the effect of transitioning other superconductor traces. As such, by selective control of the state of the different superconductor traces, the resonant frequency of the tunable superconductor resonator can be controlled to 2, 4, 8, 16, . . . , 256, etc. equally-separated resonant frequencies.

In the above embodiments of the tunable superconductor resonator 100, controllably transitioning each superconductor trace between above and below the critical electrical current density level acts to tune the superconductor trace. Such transitioning may occur in those embodiments illustrated in various embodiments as shown in FIGS. 10, 11, 12, 13, 15, 16, 18A, 18B, 20A, and 20B. In different embodiments that are within the scope of the present disclosure, however, either: a) the temperature of a portion of the superconductor trace 1302 can be controllably altered between above and below the critical temperature Tc as shown in FIG. 22 as described below; or b) the magnetic flux of a portion of the superconductor material can be altered between above and below the critical magnetic flux H_{c} as shown in FIG. 23 as described below. The superconductor resonator coil 102 having a controllably variable electrical current therethrough can generate a magnetic flux.

Control of Dynamic Tuning and/or Static Tuning

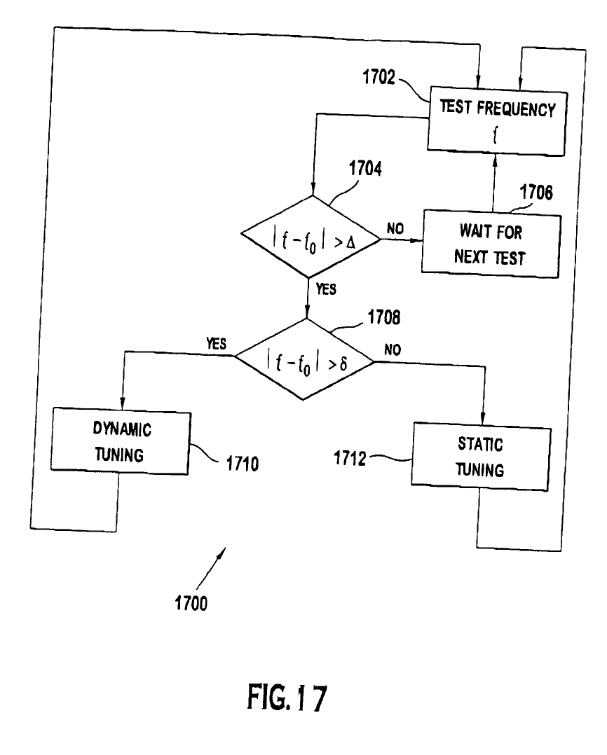

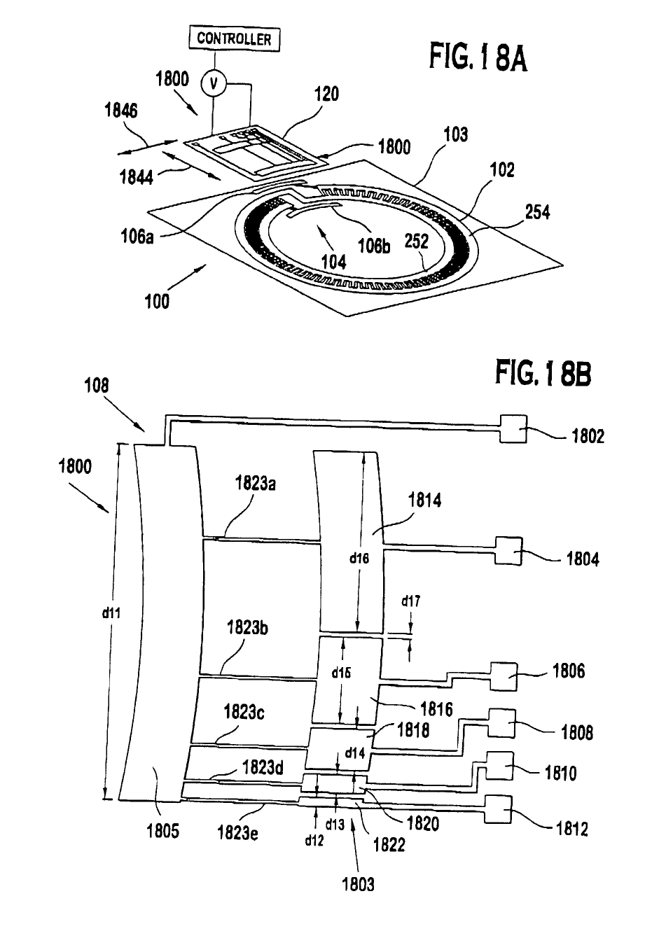

FIG. 17 shows one embodiment of method 1700 in which the controller 111 determines whether to tune the tunable superconductor resonator 100 dynamically or statically. The method 1700 can be run continuously so a coarse tuning adjustment is performed (using, e.g., dynamic tuning) followed by a fine tuning adjustment (using, e.g., static tuning). Depending on the relative sensitivities of the statically tunable portion compared with the dynamically tunable portion, the statically tunable portion may provide the coarse tuning adjustment and the dynamically tunable portion configuration may provide the fine tuning adjustment. Alternatively, the statically tunable portion may provide the fine tuning adjustment and the dynamically tunable portion configuration may provide the coarse tuning adjustment.

The method starts with step 1702 in which the controller 111 (shown, e.g., in FIGS. 1 and 15) determines a test frequency fs that represents the actual frequency at which the tunable superconductor resonator 100 is operating. The user also inputs the desired value of the frequency f_{O}. The method 1700 continues to decision step 1704 in which the controller 111 determines whether the absolute value of the desired frequency f_{O} subtracted from the test frequency fs is greater than some prescribed value. If the answer to decision step 1704 is no, then the controller 111 running the method 1700 concludes that tuning is unnecessary (since the test frequency is so close to the desired frequency), and the method 1700 continues to step 1706 to wait for the next test. As such, the method 1700 continues looping between steps 1702, 1704, and 1706 until the controller 111 determines that the difference between the desired frequency and the test frequency is a value greater than.

If the answer to decision step 1704 is yes, the controller 111 running method 1700 continues to decision step 1708. If the method reaches decision step 1708, then some tuning (either static or dynamic) is necessary. Decision step 1708 determines whether the absolute value of the difference between the actual frequency and the desired frequency is greater than. The value of exceeds the value of. If the answer to decision step 1708 is no, then static tuning is performed on the tunable superconductor resonator 100 as indicated in step 1712. By comparison, if the answer to decision step 1708 is yes, then the tunable superconductor resonator 100 is tuned using dynamic tuning as indicated in step 1710. Such a value of assumes that dynamic tuning is a relatively coarse tuning method compared to static tuning. In another embodiment of method, the location of the static tuning step 1712 and the dynamic tuning step 1710 are reversed in these instances where static turning provides a coarser tuning than dynamic tuning.

Alternate Tuning Mechanisms

The above static tuning section of the disclosure describes a mechanism by which varying the electric field applied to selected portions of a superconductor segment (either the superconductor portion 837 as illustrated in FIG. 8, or the superconductor trace as illustrated in FIGS. 9-11, 14-16, 18A, 18B, 20A, and 20B) acts to statically tune the tunable superconductor resonator 100. There are alternate tuning mechanisms that are known to effectively transition a superconductor material between its superconducting state and its non-superconducting state, as now described, which are within the intended scope of the present disclosure. Any of these tuning mechanisms that transition superconducting material (i.e., of the superconductor portion or superconductor trace) to tune the tunable superconductor resonator 100 are within the intended scope fo the present disclosure.

FIG. 22 shows another embodiment of tunable superconductor resonator 100 in which an optical heater portion 2202 is applied to the superconductor trace to control the temperature of the superconductor trace. In one embodiment, the optical heater portion 2202 includes an optical heater source that can controllably raise or lower the temperature of each one of a plurality of superconductor traces. The optical heater portion 2202 may include, e.g., a laser. The laser can apply sufficient heat to the superconductor trace to transition the trace from its superconducting state to its normal state. Therefore, the optical heater portion 2202 is deactuated if it is desired to transition the superconductor trace from its normal state to its superconducting state.

The optical heater portion 2202 has two portions, a bias optical heater portion and a pulse optical heater portion. The bias optical portion is continually applied. The bias optical portion maintains the superconductor trace near, but below, the transition level in the superconductor trace. When the pulse optical portion is actuated in combination with the bias optical portion, the temperature of the superconductor trace raised to its normal state. Using the bias optical portion in combination with the pulse optical portion limits the amount of heat applied to the superconductor trace from the pulse optical heater portion during transition. Similarly, the duration necessary time to heat the superconductor trace at a level to transition the superconductor trace from its superconducting to its normal state is brief.

The embodiment of the tunable superconductor resonators 100 shown in FIG. 22 has a single optical heater portion 2202. There can be plurality of optical heater portions 2202, with one optical heater portion applied to each superconductor trace. The plurality of optical heater portions can each be configured to transition a particular superconducting trace that each has a different respective cross sectional area from the other superconducting traces, and can upon transition between the normal state and the superconducting state, have an effect on the resonant frequency of the superconductor resonator coil 102 that is a multiple of 2ⁿ (wherein n is a positive integer) of the effect of transitioning other superconductor traces by the optical heater portions. As such, by selective control of the state of the different superconductor traces by the optical heater portions, the resonant frequency of the tunable superconductor resonator can be controlled in a digital fashion in which each superconductor trace (or superconductor portion) is configured to transition the resonant frequency of the tunable superconductor resonator by some multiple of 2ⁿ.(where n is an integer multiple) of other superconductor traces (or superconductor portions).

In the FIG. 23 embodiment of the tunable superconductor resonator 100, each superconductor trace is transitioned between normal and superconducting states by the application of a magnetic field applied to the superconductor trace. The embodiment of tunable superconductor resonators 100 shown in FIG. 23 further includes a magnetic field generator 2310. An electric current flows to the magnetic field generator 2310. One embodiment of magnetic field generator 2310 includes a resonator coil 2312 that generates a magnetic field by electric current flowing therethrough. The quantity of magnetic field generated by the resonator coil 2312 can be determined using Maxwell's equations. Application of electric current to the magnetic field generator 2310 generates a magnetic field across the superconductor trace. When a sufficient magnetic field is applied to the superconductor trace from the magnetic field generator, the superconducting material of the superconductor trace transitions from its superconducting state to its normal state. When the magnetic field level in the superconductor trace decreases below its critical magnetic field (He) level, the superconducting materials of the superconductor trace transitions back from its normal state to its superconducting state.

The embodiment of the tunable superconductor resonators 100 shown in FIG. 23 has a single magnetic field generator 2310. There can be plurality of magnetic field generators 2310, with one applied to each superconductor trace. The different magnetic field generators are each connected to a superconductor trace having a different cross sectional area, and can upon transition between the normal state and the superconducting state by one of the magnetic field generators, have an effect on the resonant frequency of the superconductor resonator coil 102 that is a multiple of 2ⁿ, wherein n is a positive integer, of the effect of transitioning other superconductor traces. As such, by selective control of the state of the different superconductor traces, the resonant frequency of the tunable superconductor resonator can be controlled in a digital fashion in which each superconductor trace (or superconductor portion) is configured to transition the resonant frequency of the tunable superconductor resonator by some multiple of 2ⁿ (where n is an integer multiple) of the superconductor traces or portions.

One embodiment of the magnetic field generator 2310 includes a bias magnetic field portion and a pulse magnetic field portion. The bias magnetic field portion, during normal operation, is applied to the superconductor trace. The applied bias magnetic field maintains the superconductor trace at a level just below that of the critical magnetic field (Hc). The pulse magnetic field portion is actuated when it is desired to transition the superconductor trace from its superconducting state to its normal state. The pulse magnetic field portion is varied to transition the superconductor trace from its normal state to its superconducting state. The variation of the magnetic field applied to the superconductor trace from the pulse magnetic field portion can be controlled. Similarly, the necessary time to apply the magnetic field to the superconductor trace to transition the superconductor trace between its superconducting and its normal states is relatively low. This reduced time results in a quick-operating device.

As such, the concepts described herein relating to controlling electric current density of the superconductor traces also apply to controlling temperature and/or magnetic current density of the superconductor traces. The superconductor traces may each be configured as a microbridge. The tunable superconductor resonator 100 can use electric current bias to provide rapid transitioning of the superconductor trace between its superconducting and its normal state.

Although the present invention has been described in connection with specific exemplary embodiments, it should be understood that various changes, substitutions and alterations could be made to the disclosed embodiments without departing from the spirit and scope of the invention as set forth in the appended claims.

1. A tunable superconductor resonator comprising:
a superconductor resonator coil; and
a variable capacitance portion that is electrically coupled to the superconductor resonator coil to vary electrical capacitance between a first capacitance state and a second capacitance state, wherein adjusting the variable capacitance portion to its first capacitance state adjusts the superconductor resonator to a first resonant frequency, and wherein adjusting the variable capacitance portion to its second capacitance state adjusts the superconductor resonator to a second resonant frequency, the variable capacitance portion comprising:
a first superconductor film portion electrically coupled to the superconductor resonator coil, and
a second superconductor film portion including a superconductor trace, wherein the superconductor trace can be transitioned between a superconducting state and a normal (non-superconducting) state, and wherein, when the superconductor trace is in its superconducting state, the variable capacitance portion is placed in the first capacitance state and, when the superconductor trace is in its normal state, the variable capacitance portion is placed in the second capacitance state.

2. The tunable superconductor resonator of claim 1, further comprising a first electrical contact pad in electrical communication with a first end of the superconductor trace and a second electrical contact pad in electrical communication with a second end of the superconductor trace, wherein the first end is remote from the second end.

3. The tunable superconductor resonator of claim 1, wherein the superconductor trace includes a plurality of superconductor traces.

4. The tunable superconductor resonator of claim 3, wherein each one of the plurality of superconductor traces has a different area.

5. The tunable superconductor resonator of claim 1, wherein the first superconductor film portion is fixed relative to the superconductor resonator coil.

6. The tunable superconductor resonator of claim 1, wherein the second superconductor film portion is movable relative to the superconductor resonator coil.

7. The tunable superconductor resonator of claim 1, wherein the superconductor trace includes a metallic superconductor.

8. The tunable superconductor resonator of claim 1, wherein the superconductor trace includes a compound superconductor.

9. The tunable superconductor resonator of claim 1, wherein the superconductor trace includes an oxide superconductor

10. A method for tuning a superconductor resonator comprising:
providing a superconductor resonator coil;
providing a variable capacitance portion electrically coupled to the superconductor resonator coil, the variable capacitance portion including a first superconductor film portion electrically coupled to the superconductor resonator coil and a second superconductor film portion including a superconductor trace;
varying the electrical capacitance of the variable capacitance portion between a first capacitance state and a second capacitance state, wherein adjusting the variable capacitance portion to its first capacitance state adjusts the superconductor resonator to its first resonant frequency and wherein adjusting the variable capacitance portion to its second capacitance state adjusts the superconductor resonator to its second resonant frequency; and
transitioning the superconductor trace between a superconducting state and a normal (non-superconducting) state, wherein, when the superconductor trace is in its superconducting state, the variable capacitance portion is converted to its first capacitance state, and when the superconductor trace is in its normal state, the variable capacitance portion is converted to its second capacitance state.

11. The method of claim 10, wherein the superconductor trace includes a plurality of superconductor traces.

12. The method of claim 11, wherein each one of the superconductor traces has a different area that forms a different capacitance.

13. An apparatus for tuning a superconductor resonator comprising:
a superconductor resonator coil;
a variable capacitance portion electrically coupled to the superconductor resonator coil, the variable capacitance portion including a first superconductor film portion electrically coupled to the superconductor resonator coil, the variable capacitance portion further includes a second superconductor film portion having a superconductor trace;
a mechanism for varying the capacitance of the variable capacitance portion between a first capacitance and a second capacitance, wherein adjusting the variable capacitance portion to its first capacitance adjusts the superconductor resonator to its first resonant frequency, and wherein adjusting the variable capacitance portion to its second capacitance adjusts the superconductor resonator to its second resonant frequency; and
a mechanism for transitioning the superconductor trace between a superconducting state and a normal (non-superconducting) state, wherein when the superconductor trace is in its superconducting state, the variable capacitance portion is converted to its first capacitance and when the superconductor trace is in its normal state, the variable capacitance portion is converted to its second capacitance.

14. The apparatus for tuning a superconductor resonator of claim 13, wherein the superconductor trace includes a plurality of superconductor traces.

15. The apparatus for tuning a superconductor resonator of claim 13, wherein each one of the superconductor traces has a different cross sectional area.

16. The apparatus for tuning a superconductor resonator of claim 13, wherein the superconductor trace includes a metallic superconductor.

17. The apparatus for tuning a superconductor resonator of claim 13, wherein the superconductor trace includes a compound superconductor.

18. The apparatus for tuning a superconductor resonator of claim 13, wherein the superconductor trace includes an oxide superconductor.

19. A method of tuning a tunable superconductor resonator comprising:
dynamically tuning the tunable superconductor resonator to a level slightly below a critical value; and
statically tuning the tunable superconductor resonator between levels above and below the critical value.

20. The method of tuning of claim 19, wherein the critical value is an electric current density critical value.

21. The method of claim 19, wherein the critical value is a temperature critical value.

22. The method of claim 19, wherein the critical value is a magnetic flux critical value.

23. The method of claim 19, wherein the tunable superconductor resonator includes a metallic superconductor.

24. The method of claim 19, wherein the tunable superconductor resonator includes a compound superconductor.

25. The method of claim 19, wherein the tunable superconductor resonator includes an oxide superconductor.

26. A method of tuning a tunable superconductor resonator comprising:
determining that the tunable superconductor resonator requires tuning;
coarsely tuning the tunable superconductor resonator to within a coarse tuning range; and
finely tuning the tunable superconductor resonator to within a fine tuning range.

27. The method of claim 26, wherein the coarsely tuning is performed using dynamic tuning and the finely tuning is performed using static tuning.

28. The method of claim 26, wherein the coarsely tuning is performed using static tuning and the finely tuning is performed using dynamic tuning.

29. A tunable superconductor resonator comprising:
a superconductor resonator coil; and
a variable capacitance portion that included as a portion of the superconductor resonator coil, wherein the variable capacitance portion can be transitioned between a first capacitance and a second capacitance, and wherein adjusting the variable capacitance portion to its first capacitance adjusts the superconductor resonator to a first resonant frequency, and adjusting the variable capacitance portion to its second capacitance adjusts the superconductor resonator to a second resonant frequency, the variable capacitance portion comprising:
an electric current source including a first lead and a second lead, wherein the electric current source can produce an electric current from the first lead to the second lead, wherein the first lead is electrically connected to a first axial location on the superconductor resonator coil and the second lead is electrically connected to a second axial location on the superconductor resonator coil, wherein the first axial location is spaced along the superconductor resonator coil from the second axial location.

30. The tunable superconductor resonator of claim 29, wherein a portion of the variable capacitance portion is in a normal state when the variable capacitance portion is in the first capacitance state; and wherein the portion of the variable capacitance portion is in a superconducting state when the variable capacitance portion is in the second capacitance state.

31. The tunable superconductor resonator of claim 30, wherein the portion of the variable capacitance portion includes a plurality of superconductor traces.

32. The tunable superconductor resonator of claim 29, wherein the tunable superconductor resonator is statically tunable.

33. A dynamically tunable superconductor resonator comprising:
a superconductor resonator coil; and
a variable capacitance portion that can be transitioned between a first capacitance and a second capacitance, wherein adjusting the variable capacitance portion to its first capacitance adjusts the superconductor resonator to a first resonant frequency and adjusting the variable capacitance portion to its second capacitance state adjusts the superconductor resonator to a second resonant frequency, the variable capacitance portion comprising
a first superconductor film portion being electrically connected to opposed ends of the superconductor resonator coil,
a movable substrate having a second superconductor film portion deposited thereon, and
an actuator, that when actuated, displaces the second superconductor film portion relative to the first superconductor film portions.

34. The dynamically tunable superconductor resonator of claim 33 wherein the actuator includes one from the group of a micro-electromechanical (MEM) actuator, a piezoelectric actuator, or a mini-electric motors.

35. The dynamically tunable superconductor resonator of claim 33, wherein the second superconductor film portion is arranged substantially parallel to the first superconductor film portion.

36. A tunable superconductor resonator comprising:
a superconductor resonator coil; and
a variable capacitance portion that is electrically coupled to the superconductor resonator coil to vary capacitance between a first capacitance and a second capacitance, wherein adjusting the variable capacitance portion to its first capacitance adjusts the superconductor resonator to a first resonant frequency, and wherein adjusting the variable capacitance portion to a second capacitance adjusts the superconductor resonator coil to a second resonant frequency, the variable capacitance portion comprising:
a first superconductor film portion electrically coupled to a first end of the superconductor resonator coil,
a second superconductor film portion electrically coupled to a second end of the superconductor resonator coil, the first end of the superconductor resonator coil being on opposite ends of the superconductor resonator coil from the second end of the superconductor resonator coil; and
a third superconductor film portion including a first superconductor portion, a second superconductor portion, and a superconductor trace, the superconductor trace extending between the first superconductor portion and the second superconductor portion, wherein the superconductor trace can be transitioned between a superconducting state and a normal (non-superconducting) state, and wherein the first superconductor portion is capacitively coupled to the first superconductor film portion, the second superconductor portion is capacitively coupled to the second superconductor film portion, and wherein, when the superconductor trace is in its superconducting state, the tunable superconductor resonator resonates at the first resonant frequency, and, when the superconductor trace is in its normal state, the tunable superconductor resonator resonates at the second resonant frequency.

37. The tunable superconductor resonator of claim 36, wherein there are a plurality of the third superconductor film portions, each one of the plurality of third superconductor film portions including one first superconductor portion, one second superconductor portion, and one superconductor trace.

38. The tunable superconductor resonator of claim 36, wherein the superconductor trace converts between its normal state and its superconducting state at a critical value.

39. The tunable superconductor resonator of claim 38, wherein the critical value is an electric current density critical value.

40. The tunable superconductor resonator of claim 38, wherein the critical value is a temperature critical value.

41. The tunable superconductor resonator of claim 38, wherein the critical value is a magnetic flux critical value.

42. The tunable superconductor resonator of claim 36, wherein the superconductor resonator coil includes a metallic superconductor.

43. The tunable superconductor resonator of claim 36, wherein the superconductor resonator coil includes a compound superconductor.

44. The tunable superconductor resonator of claim 36, wherein the superconductor resonator coil includes an oxide superconductor.

45. A tunable superconductor resonator comprising:
a superconductor resonator coil; and
a variable capacitance portion that is electrically coupled to the superconductor resonator coil to vary capacitance between a first capacitance and a second capacitance, wherein adjusting the variable capacitance portion to its first capacitance adjusts the superconductor resonator to a first resonant frequency, and wherein adjusting the variable capacitance portion to its second capacitance adjusts the superconductor resonator to its second resonant frequency, the variable capacitance portion comprising:
a first superconductor film portion,
a second superconductor film portion electrically coupled to a first end of the superconductor resonator coil,
a third semiconductor film portion;
a superconductor portion and a superconductor trace, the superconductor trace extends between the superconductor portion and the first superconductor film portion, the superconductor trace can transition between a superconducting state and a normal (non-superconducting) state, the first capacitive film portion is capacitively coupled to the third superconductor film portion,
a common electric junction electrically coupled to the superconductor portion, the common electric junction also being electrically coupled to the second end of the superconductor resonator coil, the second end of the superconductor resonator coil being on opposite ends of the superconductor resonator coil from the first end of the superconductor resonator coil, and
wherein, when the superconductor trace is in its superconducting state, the tunable superconductor resonator resonates at its first resonant frequency and, when the superconductor trace is in its normal state, the tunable superconductor resonator resonates at its second resonant frequency.

46. The tunable superconductor resonator of claim 45, wherein there are a plurality of the superconductor portions and a plurality of the superconductor traces, each superconductor trace extends between one superconductor portion and the first superconductor film portion, said each superconductor trace can transition between a superconducting state and a normal (non-superconducting) state.

47. The tunable superconductor resonator of claim 45, wherein the superconductor trace converts between its normal state and its superconducting state at a critical value.

48. The tunable superconductor resonator of claim 47, wherein the critical value is an electric current density critical value.

49. The tunable superconductor resonator of claim 47, wherein the critical value is a temperature critical value.

50. The tunable superconductor resonator of claim 47, wherein the critical value is a magnetic flux critical value.

51. The tunable superconductor resonator of claim 45, wherein the superconductor resonator coil includes a metallic superconductor.

52. The tunable superconductor resonator of claim 45, wherein the superconductor resonator coil includes a compound superconductor.

53. The tunable superconductor resonator of claim 45, wherein the superconductor resonator coil includes an oxide superconductor.
